(19) United States
(12) Patent Application Publication
(10) Pub. No.: US 2025/0329740 A1
(43) Pub. Date: Oct. 23, 2025

(54) AMINO ACID CONCATEMER SYNERGISTIC SULFUR CONVERSION CATALYST FOR LITHIUM-SULFUR BATTERY AND ITS PREPARATION METHOD AND APPLICATION

(71) Applicant: Wenzhou University, Wenzhou City (CN)

(72) Inventors: Shuo YANG, Wenzhou City (CN); Haohao WANG, Wenzhou City (CN); Zhi YANG, Wenzhou City (CN); Dong CAI, Wenzhou City (CN); Peihang LI, Wenzhou City (CN); Jinchen JIANG, Wenzhou City (CN); Huagui NIE, Wenzhou City (CN)

(73) Assignee: Wenzhou University, Wenzhou City (CN)

(21) Appl. No.: 18/789,742

(22) Filed: Jul. 31, 2024

(30) Foreign Application Priority Data
Apr. 18, 2024 (CN) 2024104691604

(51) Int. Cl. H01M 4/62; H01M 4/02; H01M 4/04; H01M 4/136; H01M 10/052

(52) U.S. Cl. CPC H01M 4/625; H01M 4/0404; H01M 4/136; H01M 10/052; H01M 2004/028

(57) ABSTRACT

The invention provides an amino acid concatemer synergistic sulfur conversion catalyst for lithium-sulfur battery and its preparation method and application. The invention uses peptide-based materials serine (Ser), histidine (His) and aspartic acid (Asp) to construct a peptide-based mimetic enzyme, that is, Ser-His-Asp catalytic triplet, which retains the function of the enzyme while reducing the inherent complexity of the enzyme. The synergistic effect between the three significantly improves the redox reaction kinetics of lithium-sulfur battery, promotes the efficient conversion of polysulfide, accelerates Li⁺ transmission, and improves battery performance.

### TECHNICAL FIELD

The invention relates to the technical field of lithium-sulfur battery, in particular to an amino acid concatemer synergistic sulfur conversion catalyst for lithium-sulfur battery and its preparation method and application.

### BACKGROUND ART

With the global energy crisis and the increasing pollution of human survival environment, countries around the world are actively promoting the development of new energy to reduce dependence on fossil fuels. The development of new energy is inseparable from the continuous progress of electrochemical energy storage technology, therefore, it is urgent to develop an electrochemical energy storage system with high energy density. Among various candidate schemes, lithium-sulfur battery, as one of the core battery technologies in the post-lithium-ion battery era, has received extensive attention since its emergence in 1962. However, the shuttle effect and its slow redox kinetics severely limit the practical application of lithium-sulfur battery. The soluble polysulfide generated during the charge and discharge process diffuses to the lithium anode under the action of electric field and concentration difference, resulting in a shuttle effect, and causing problems such as self-discharge and low Coulombic efficiency. In addition, since the sulfur conversion reaction involves the conversion between liquid-solid and solid-solid phases, it is restricted by the high energy barrier, resulting in slow reaction kinetics, at the end of discharge, it is difficult for polysulfide to be completely converted into solid phase Li2S, which will cause capacity loss. In recent years, significant progress has been made in limiting the shuttle effect and accelerating the conversion kinetics of polysulfide by introducing catalyst.

Enzyme is a natural catalyst, which shows amazing catalytic ability in various physiological stress processes. Natural enzyme based on peptide-based material has excellent performance in improving lithium-sulfur battery performance and extending battery life. However, due to the large molecular weight and complex structure of natural enzyme, the structure-activity relationship and catalytic mechanism between natural enzyme and sulfur conversion in lithium-sulfur battery are difficult to interpret. Inspired by the catalytic activity of natural enzyme derived from specific amino acid on the peptide chain, how to construct peptide-based mimetic enzyme with similar function to natural enzyme but a simple and controllable structure based on peptide-based material to improve the performance of lithium-sulfur battery has become an urgent problem to be solved.

### SUMMARY OF THE INVENTION

The purpose of the invention is to overcome the shortcomings and deficiencies of the existing technology, and to provide an amino acid concatemer synergistic sulfur conversion catalyst for lithium-sulfur battery and its preparation method and application.

The technical scheme of the invention is as follows: a first aspect of the invention provides an amino acid concatemer synergistic sulfur conversion catalyst for lithium-sulfur battery, comprising an amino acid concatemer, the amino acid concatemer comprises serine (Ser), histidine (His), and aspartic acid (Asp).

Preferably, comprising a conductive matrix, the amino acid concatemer is compounded on the conductive matrix.

Preferably, the conductive matrix is a carbon material. The carbon material has high conductivity. Common conductive carbon material comprises carbon nanotube, graphene, porous carbon, etc.

Preferably, the carbon material is carbon nanotube.

A second aspect of the invention provides a preparation method for an amino acid concatemer synergistic sulfur conversion catalyst for lithium-sulfur battery as described above, comprising following steps: dispersing each amino acid and carbon material into a solvent for ultrasonic treatment, selecting one or more conventional solvents, such as N-methyl pyrrolidone (NMP), N,N-dimethylformamide (DMF), N,N-diethylformamide (DEF), dimethyl sulfoxide (DMSO), tetrahydrofuran (THF), water and alcohols.

Preferably, a mass ratio of carbon material to Ser, His and Asp is 20˜60:x:y:z, x+y+z=3.

A third aspect of the invention provides a cathode material of lithium-sulfur battery, comprising an active material sulfur-loaded cathode and an amino acid concatemer synergistic sulfur conversion catalyst for lithium-sulfur battery as described above. At present, the common active material sulfur-loaded cathode comprises carbon nanotube-sulfur composite material, graphene-sulfur composite material, porous carbon-sulfur composite material, and carbon-sulfur composite material containing polar additive.

A fourth aspect of the invention provides a cathode of lithium-sulfur battery, comprising a current collector and a lithium-sulfur battery cathode material coated on the current collector as described above. Among them, the current collector can be a variety of current collectors known to technicians in this field, such as aluminum foil, copper foil, nickel-plated steel strip, etc.

A fifth aspect of the invention provides a preparation method for cathode of lithium-sulfur battery as described above, comprising the following steps: dispersing the lithium-sulfur battery cathode material and a binder as described above into the solvent to form a slurry, then uniformly coating it on the current collector, and dried.

The binder can use all the binders known in this field that can be used for lithium-sulfur battery.

The conductive agent can be added to increase the conductivity of the electrode and reduce the internal resistance of the battery, conductive agent can choose one or more of conductive carbon black, acetylene black, nickel powder, copper powder and conductive graphite, a content of conductive agent is generally 0-15 wt % in cathode material, preferably 0-10 wt %.

The solvent can choose conventional solvent, such as NMP, DMF, DEF, DMSO, THE and one or more of water and alcohols. An amount of solvent can make the slurry be coated on the current collector.

A sixth aspect of the invention provides the lithium-sulfur battery, comprising an anode, a separator, a non-aqueous electrolyte, and a cathode as described above.

The beneficial effects of the invention are as follows: the invention uses peptide-based material such as Ser, His and Asp to construct a peptide-based mimetic enzyme, namely Ser-His-Asp catalytic triad, which reduces the inherent complexity of the enzyme while retaining the function of the enzyme. Asp adsorbs polysulfide by strong electrostatic attraction; through the nucleophilic attack ability of hydroxyl group, Ser is more likely to attack the S—S bond through deprotonation and ‘electronic stretching effect’, which promotes the cleavage of long-chain polysulfides to form short-chain polysulfide intermediates; the His synchronous transfer of N-rich atom promotes the transmission of Li+ in the electrolyte. The synergistic effect between the three significantly improves the redox reaction kinetics of lithium-sulfur battery, and promotes the efficient conversion of polysulfide, accelerates Li+ transmission, and improves battery performance.

### BRIEF DESCRIPTION OF DRAWINGS

In order to more clearly explain the technical scheme in the embodiment or existing technology of the invention, the following will briefly introduce the drawings needed in the embodiment or existing technology description, obviously, the drawings in the following description are only some embodiments of the invention, for ordinary technicians in this field, obtaining other drawings according to these drawings still belongs to the scope of the invention without paying creative labor.

FIG. 1 shows the synergistic effect of Ser, His and Asp;

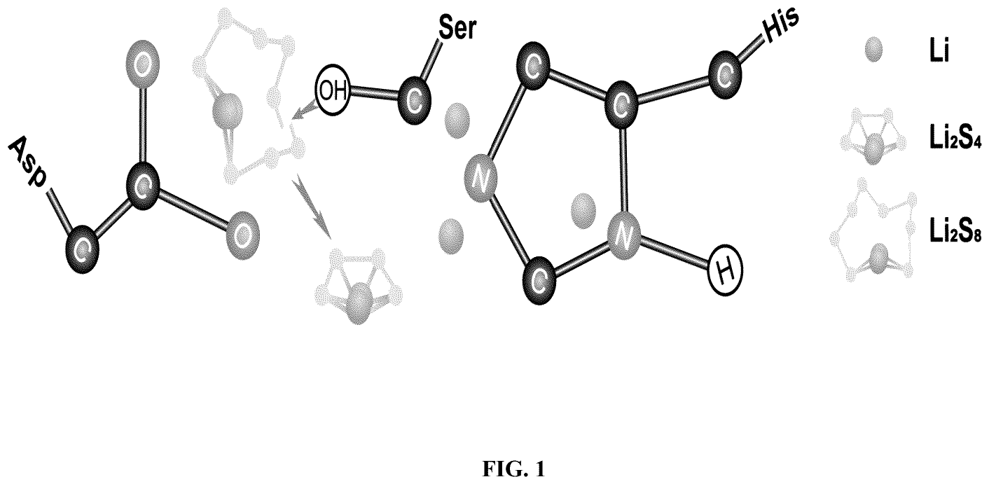

FIG. 2(a) shows the CV curves of the first four cycles of CNT/S-Ser/His/Asp cathode.

FIG. 2(b) shows the CV curves of the first four cycles of CNT/S cathode.

FIG. 3 shows the comparison of CV curves of the third cycle of CNT/S-Ser/His/Asp and CNT/S cathodes.

FIG. 4 shows the voltage polarization comparison (ΔV, which is obtained by subtracting the voltage at Peak ii from the voltage at Peak iii) obtained from the CV curves in FIG. 2.

FIG. 5(a) shows the Tafel slope of the reduction and oxidation Peak i in FIG. 2.

FIG. 5(b) shows the Tafel slope of the reduction and oxidation Peak ii in FIG. 2.

FIG. 5(c) shows the Tafel slope of the reduction and oxidation Peak iii in FIG. 2.

FIG. 6 shows the PITT curves of CNT/S-Ser/His/Asp and CNT/S cathodes.

FIG. 7(a) shows the Li₂S nucleation curve of CNT-Ser/His/Asp cathode.

FIG. 7(b) shows the Li₂S nucleation curve of CNT cathode.

FIG. 8(a) shows the in-situ UV-Vis absorption spectra of CNT/-Ser/His/Asp cathode during discharge.

FIG. 8(b) shows the in-situ UV-Vis absorption spectra of CNT/S cathode during discharge.

FIG. 9(a) shows the contour map of in-situ-UV-Vis absorption spectra of sulfur species of CNT/S-Ser/His/Asp cathode.

FIG. 9(b) shows the contour map of in-situ-UV-Vis absorption spectra of sulfur species of CNT/S cathode;

FIG. 10(a) shows the absorbance of the normalized UV-Vis absorption spectra of CNT/S-Ser/His/Asp and CNT/S cathodes during discharge: S₈²⁻.

FIG. 10(b) shows the absorbance of the normalized UV-Vis absorption spectra of CNT/S-Ser/His/Asp and CNT/S cathodes during discharge: S₆²⁻.

FIG. 10(c) shows the absorbance of the normalized UV-Vis absorption spectra of CNT/S-Ser/His/Asp and CNT/S cathodes during discharge: S₄²⁻.

FIG. 10(d) shows the absorbance of the normalized UV-Vis absorption spectra of CNT/S-Ser/His/Asp and CNT/S cathodes during discharge: S₃²⁻/S₃*⁻.

FIG. 11(a) shows the in-situ Raman spectra of CNT/S-Ser/His/Asp cathode during discharge,

FIG. 11(b) shows the in-situ Raman spectra of CNT/S cathode during discharge.

FIG. 12 shows the rate performance of CNT/S-Ser/His/Asp and CNT/S cathodes from 0.2 to 5 C;

FIG. 13(a) shows the voltage-capacity curves of the second cycle of CNT/S-Ser/His/Asp and CNT/S cathodes at 0.2 C.

FIG. 13(b) shows the voltage-capacity curves of the second cycle of CNT/S-Ser/His/Asp and CNT/S cathodes at 0.5 C.

FIG. 13(c) shows the voltage-capacity curves of the second cycle of CNT/S-Ser/His/Asp and CNT/S cathodes at 1 C.

FIG. 13(d) shows the voltage-capacity curves of the second cycle of CNT/S-Ser/His/Asp and CNT/S cathodes at 2 C.

FIG. 13(e) shows the voltage-capacity curves of the second cycle of CNT/S-Ser/His/Asp and CNT/S cathodes at 3 C.

FIG. 13(f) shows the voltage-capacity curves of the second cycle of CNT/S-Ser/His/Asp and CNT/S cathodes at 5 C.

FIG. 14 shows the cycle performance of CNT/S-Ser/His/Asp and CNT/S cathodes at 0.5 C;

FIG. 15(a) shows the long cycle performance of CNT/S-Ser/His/Asp and CNT/S cathodes at 0.1 C when the sulfur loading is 4 mg cm⁻², E/S ratio is 10 μL mg⁻¹.

FIG. 15(b) shows the long cycle performance of CNT/S-Ser/His/Asp and CNT/S cathodes at 0.1 C when the sulfur loading is 4 mg cm⁻², E/S ratio is 10 μL mg⁻¹.

FIG. 16 shows the photo of Li₂S₆ solution adsorbed by different materials at different time intervals. Wherein FIG. 16(a) is at 3 minutes, FIG. 16(b) is at 10 minutes, FIG. 16(c) is at 2 hours and FIG. 16(d) is at 4 hours.

FIG. 17(a) shows the high-resolution O 1s XPS spectra of Ser before and after adsorption of Li₂S₆ solution.

FIG. 17(b) shows the high-resolution O 1s XPS spectra of His before and after adsorption of Li₂S₆ solution.

FIG. 17(c) shows the high-resolution O 1s XPS spectra of Asp before and after adsorption of Li₂S₆ solution.

FIG. 17(d) shows the high-resolution N Is XPS spectra of Ser before and after adsorption of Li₂S₆ solution.

FIG. 17(e) shows the high-resolution N Is XPS spectra of His before and after adsorption of Li₂S₆ solution.

FIG. 17(f) shows the high-resolution N Is XPS spectra of Asp before and after adsorption of Li₂S₆ solution.

FIG. 17(g) shows the Li Is XPS spectra of Asp, His and Ser before and after adsorption of Li₂S₆ solution;

FIG. 17(h) shows the S 2p XPS spectra of Asp, His and Ser before and after adsorption of Li₂S₆ solution;

FIG. 18 shows the CV curves of symmetrical cells with Li₂S₆ electrolyte as active component and CNT-Ser/His/Asp, CNT-Ser, CNT-His, CNT-Asp and CNT as electrodes at 50 mV s⁻¹.

FIG. 19 shows the EIS curves of CNT/S-Ser/His/Asp, CNT/S-Ser/His, CNT/S-Ser/Asp and CNT/S cathodes after 10 cycles.

FIG. 20 shows the equivalent circuit of fitting EIS data.

FIG. 21 shows the relationship between −Z″ and ω^{-1/2} of CNT/S-Ser/His/Asp, CNT/S-Ser/His, CNT/S-Ser/Asp and CNT/S cathodes at low frequency.

FIG. 22 shows D_{Li}_{⁺} and R_{ct} of different cathodes calculated based on EIS curves.

FIG. 23(a) shows the GITT curves of CNT/S-Ser/His/Asp and CNT/S cathodes at the second discharge at 0.05 C.

FIG. 23(b) shows the Li⁺ diffusion coefficient of CNT/S-Ser/His/Asp and CNT/S cathodes at the second discharge at 0.05 C;

FIG. 24(a) shows the configuration of Asp adsorbing Li₂S₆.

FIG. 24(b) shows the configuration of His adsorbing Li₂S₆.

FIG. 24(c) shows the configuration of Ser adsorbing Li₂S₆.

FIG. 25(a) is the difference charge density diagram after Asp adsorbing Li₂S₈, in which the yellow represents the obtained electron and the blue represents the lost electron.

FIG. 25(b) is the difference charge density diagram after His adsorbing Li₂S₈, in which the yellow represents the obtained electron and the blue represents the lost electron.

FIG. 25(c) is the difference charge density diagram after Ser adsorbing Li₂S₈, in which the yellow represents the obtained electron and the blue represents the lost electron.

FIG. 26 shows the adsorption energy of Ser, His and Asp for Li₂S₆.

FIG. 27 shows the Gibbs free energy of Ser, His and Asp in the sulfur reduction process.

FIG. 28 is the battery performance distribution map drawn according to Table 2.

FIG. 29 shows the rate performance comparison of CNT/S-Ser/His/Asp cathodes with different ratios (light blue: Ser:His:Asp=1:1:1; deep blue: Ser:His:Asp=1.37:1:0.63).

### DETAILED DESCRIPTION OF THE EMBODIMENTS

In order to make the purpose, technical scheme and advantages of the invention more clear, the following will further describe the invention in detail in combination with the drawings.

The reagents used in the embodiments and the ratios of the invention are shown in Table 1 below:

TABLE 1
Main drugs used

| | Specification | |
|---|---|---|
| Reagent name | (purity) | Factory |
| Serine (Ser) | 99.9% | Meryer |
| Histidine (His) | 99.9% | Meryer |
| Aspartic acid (Asp) | 99.9% | Meryer |
| N-methyl pyrrolidone | Anhydrous grade, | Aladdin |
| (NMP) | 99.5% | |
| Carbon nanotube (CNT) | ≥99% | Aladdin |
| Highpurity sulfur (S) | 99.999% | Aladdin |
| Lithium-sulfur electrolyte | battery grade | DodoChem |
| Dimethyl sulfoxide | Anhydrous solvent | Aladdin |
| (DMSO) | grade | |
| Lithium sulphite (Li2S) | 99.98% | Aladdin |
| 1,3-dioxolane (DOL) | Battery grade | DodoChem |
| Dimethoxyethane (DME) | Battery grade | DodoChem |
| Polyvinylidene fluoride | Analytical pure | Yancheng Haokang |
| (PVDF) | | Fluoride Products |
| | | Co., Ltd. |
| Lithium sheet (Li) | Battery grade | China Energy Lithium |
| | | Co., Ltd. |
| Separator | Technical grade | Shenzhen Kejing Zhida |
| | | Technology Co., Ltd. |
| Aluminium foil | 25 μm | Shenzhen Kejing Zhida |
| | | Technology Co., Ltd. |
| Carbon paper | Technical grade | Kelude Company |
| Coin battery shell | CR2025 | Kelude Company |

The carbon-sulfur (C/S) composite material in each embodiment and each ratio of the invention is prepared by the following method: 20 wt % carbon (CNT) and 80 wt % sulfur(S) are placed in a mortar for grinding for 1h, and then the mixture is transferred to a weighing bottle, then it is heated in an oven for 12 h and cooled to room temperature, in order to ensure the fine C/S particles are obtained, the final C/S composite material is obtained after filtration and screening.

### Embodiment 1

(1) CNT and Ser, His, Asp are dispersed in NMP solution at a mass ratio of 42:x:y:z (x+y+z=3) for ultrasonic treatment for 3h, so as to obtain CNT-Ser/His/Asp composite material; wherein, x=1, y=1, z=1;

(2) 80 wt % C/S composite material, 15 wt % CN-Ser/His/Asp composite material prepared in Step (1) and 5 wt % PVDF are combined in NMP solution, after stirring, the slurry is coated on the aluminum foil (scraper: 200-300 μm) and baked in an oven at 55° C. for 8h, after drying, it is cut into a circular disk with a radius of 7 mm by using a chipper to obtain a CNT/S-Ser/His/Asp cathode with low surface density.

### Embodiment 2

The difference between Embodiment 2 and Embodiment 1 is: x=1.11, y=0.66, z=1.23. Embodiment 3.

The difference between Embodiment 3 and Embodiment 1 is: x=1.20, y=1.06, z=0.74. Embodiment 4.

The difference between Embodiment 4 and Embodiment 1 is: x=1.27, y=0.74, z=0.99. Embodiment 5.

The difference between Embodiment 5 and Embodiment 1 is: x=0.78, y=1.10, z=1.12. Embodiment 6.

The difference between Embodiment 6 and Embodiment 1 is: x=1.13, y=1.21, z=0.66. Embodiment 7.

The difference between Embodiment 7 and Embodiment 1 is: x=1.37, y=1.01, z=0.62. Embodiment 8.

The difference between Embodiment 8 and Embodiment 1 is: x=0.96, y=0.99, z=1.05. Embodiment 9.

The difference between Embodiment 9 and Embodiment 1 is: x=1.20, y=0.78, z=1.02. Embodiment 10.

The difference between Embodiment 10 and Embodiment 1 is: x=0.78, y=1.10, z=1.12.

### Embodiment 11

The difference between Embodiment 11 and Embodiment 1 is: x=0.14, y=1.84, z=1.02.

### Ratio 1

80 wt % C/S composite material, 15 wt % CNT and 5 wt % PVDF are combined in NMP solution, after stirring, the slurry is coated on the aluminum foil (scraper: 200-300 μm) and baked in an oven at 55° C. for 8h, after drying, it is cut into a circular disk with a radius of 7 mm by using a chipper to obtain a CNT/S cathode with low surface density.

### Ratio 2.

(1) CNT and Ser are dispersed in NMP solution at a mass ratio of 42:3 for ultrasonic treatment for 3h, so as to obtain CNT-Ser composite material;

(2) 80 wt % C/S composite material, 15 wt % CN-Ser composite material prepared in Step (1) and 5 wt % PVDF are combined in NMP solution, after stirring, the slurry is coated on the aluminum foil (scraper: 200-300 μm) and baked in an oven at 55° C. for 8h, after drying, it is cut into a circular disk with a radius of 7 mm by using a chipper to obtain a CNT/S-Ser cathode with low surface density.

### Ratio 3.

(1) CNT and His are dispersed in NMP solution at a mass ratio of 42:3 for ultrasonic treatment for 3h, so as to obtain CNT-Ser composite material;

(2) 80 wt % CNT/S composite material, 15 wt % CNT-His composite material prepared in Step (1) and 5 wt % PVDF are combined in NMP solution, after stirring, the slurry is coated on the aluminum foil (scraper: 200-300 μm) and baked in an oven at 55° C. for 8h, after drying, it is cut into a circular disk with a radius of 7 mm by using a chipper to obtain a CNT/S-His cathode with low surface density.

### Ratio 4.

(1) CNT and Asp are dispersed in NMP solution at a mass ratio of 42:3 for ultrasonic treatment for 3h, so as to obtain CNT-Ser composite material;

(2) 80 wt % CNT/S composite material, 15 wt % CNT-Asp composite material prepared in Step (1) and 5 wt % PVDF are combined in NMP solution, after stirring, the slurry is coated on the aluminum foil (scraper: 200-300 μm) and baked in an oven at 55° C. for 8h, after drying, it is cut into a circular disk with a radius of 7 mm by using a chipper to obtain a CNT/S-Asp cathode with low surface density.

The characterization and electrochemical performance test are conducted on the above embodiments and ratios, the performance test and characterization result are as follows:

### 1. Electrochemical Behavior Analysis.

The intrinsic catalytic activity of the peptide-based mimetic enzyme catalyst (Ser-His-Asp) in the reaction kinetics of soluble polysulfide conversion to Li₂S is studied by cyclic voltammetry (CV), potentiostatic intermittent titration technique (PITT) and galvanostatic intermittent titration technique (GITT) experiments, which involves liquid-liquid and liquid-solid conversion.

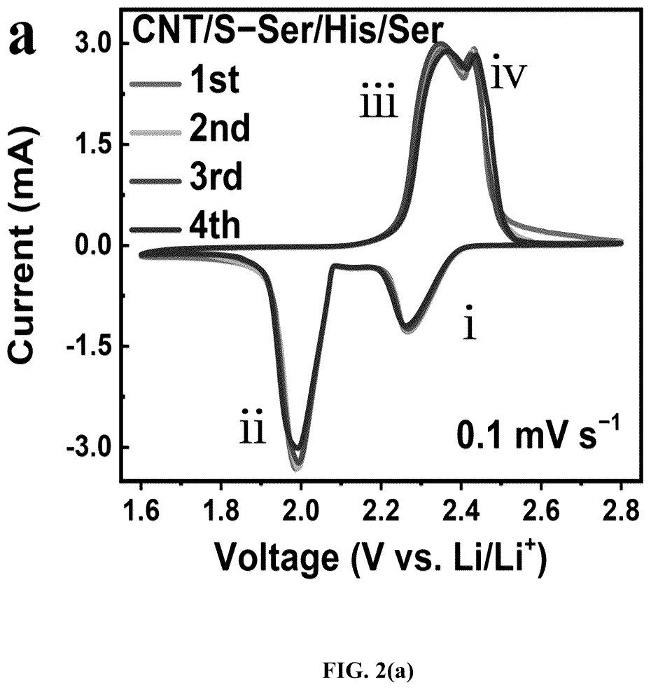

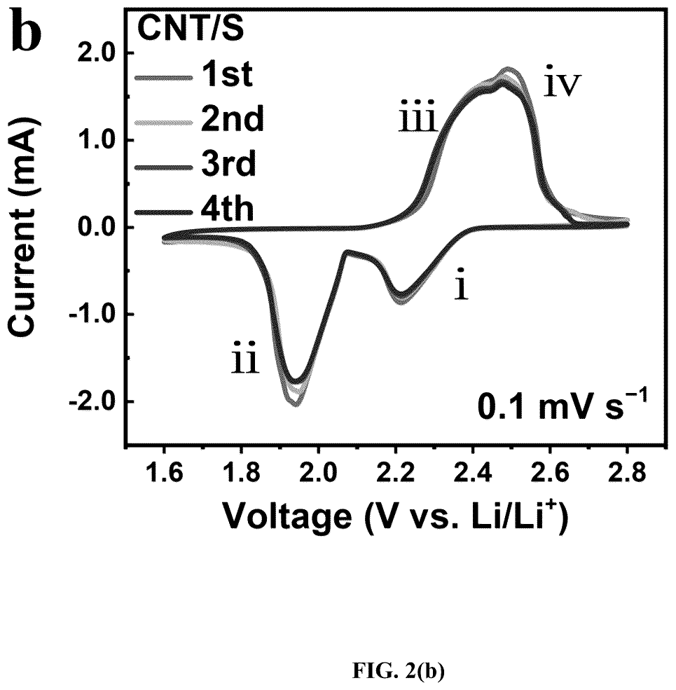

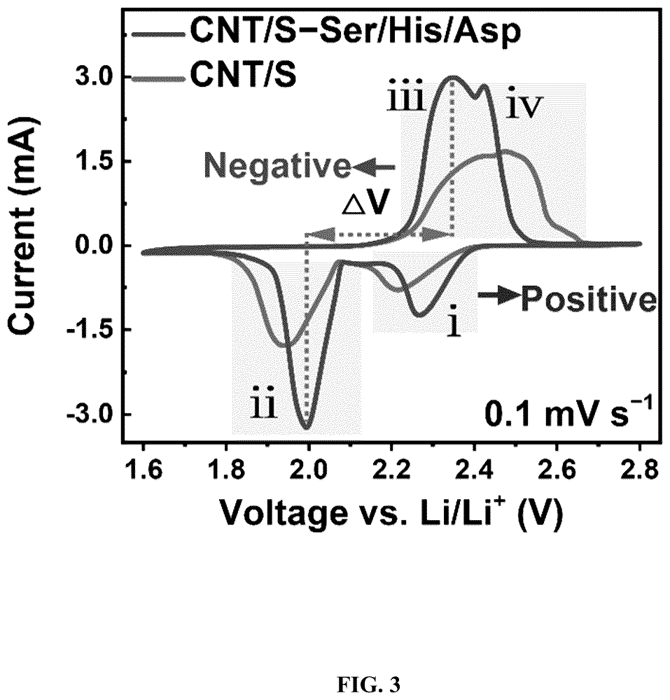

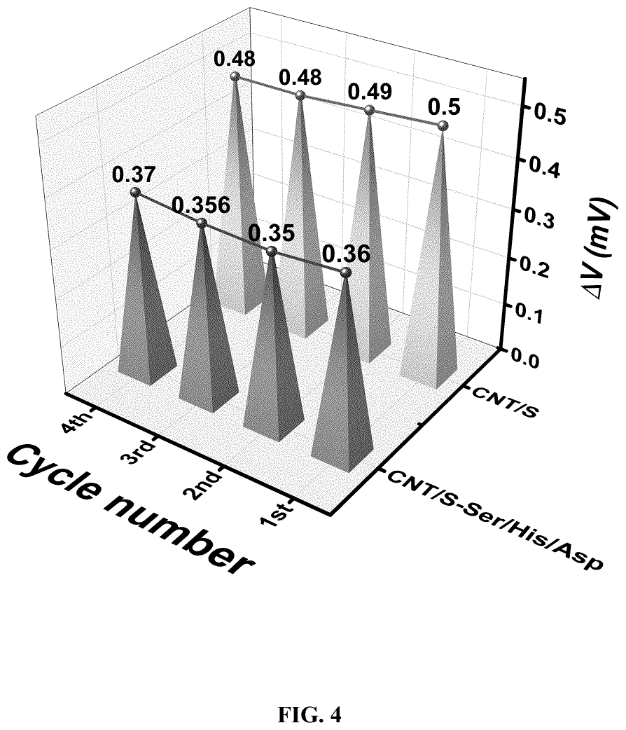

Firstly, the typical CV curves of CNT/S-Ser/His/Asp cathode prepared by Embodiment 2 and CNT/S cathode prepared by Ratio 1 are recorded at a scanning rate of 0.1 mVs⁻¹ in the range of 2.8˜1.6 V. Two reduction peaks (Peak i and Peak ii) and two overlapping oxidation peaks (Peak iii and Peak iv) (see FIG. 2a, b) are observed at 2.27, 1.97V and 2.38, 2.47V, respectively, which is consistent with traditional lithium-sulfur battery. Among them, Peak i is related to the reduction of active sulfur substance to soluble long-chain polysulfide (4≤n≤8); peak ii is related to the further reduction of soluble polysulfide to the final solid-state discharge product (Li₂S and Li₂S₂). In the reverse scan curve, Peak iii and Peak iv are attributed to the reversible conversion of Li₂S into long-chain polysulfides, and then into active sulfur. During the cycle after battery activation, the peak position and peak intensity of CNT/S-Ser/His/Asp cathode do not change significantly, indicating that CNT/S-Ser/His/Asp cathode has excellent oxidation-reduction reversibility and cycle stability. Further, the CV curves of the third cycle are selected for comparison (see FIG. 3), wherein the CNT/S-Ser/His/Asp cathode exhibits a more positive reduction potential, a more negative oxidation potential, a larger peak current, and a smaller polarization voltage (ΔV, the potential difference between Peak ii and Peak iii). The polarization voltage difference of the first four cycles of CNT/S-Ser/His/Asp cathode is 0.36,0.35,0.36 and 0.37 mV, respectively, which is smaller than that of CNT/S cathode (0.5,0.49,0.48 and 0.48 mV) (see FIG. 4). These results show that the CNT/S-Ser/His/Asp cathode has good redox kinetics in both liquid-liquid and liquid-solid conversion reactions.

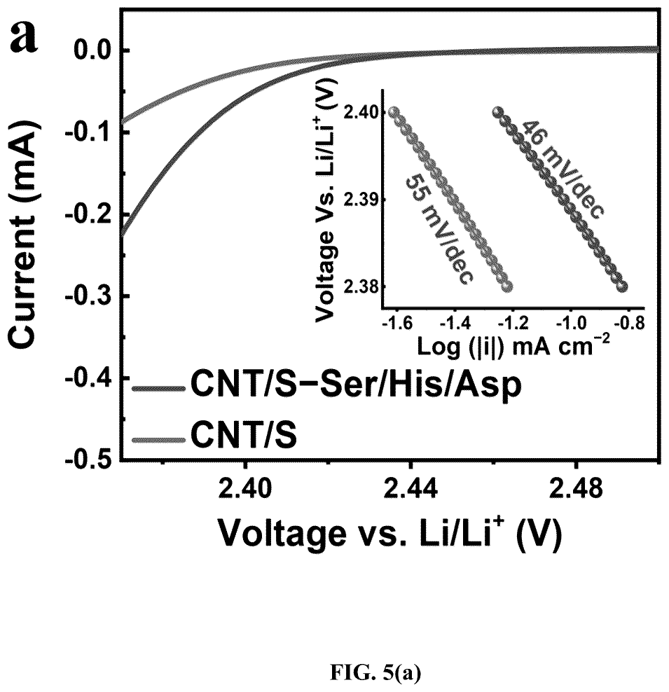

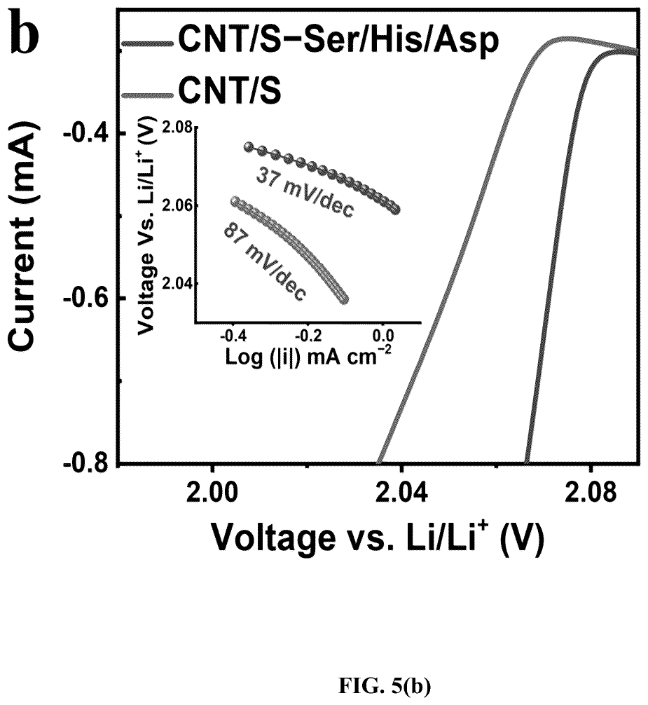

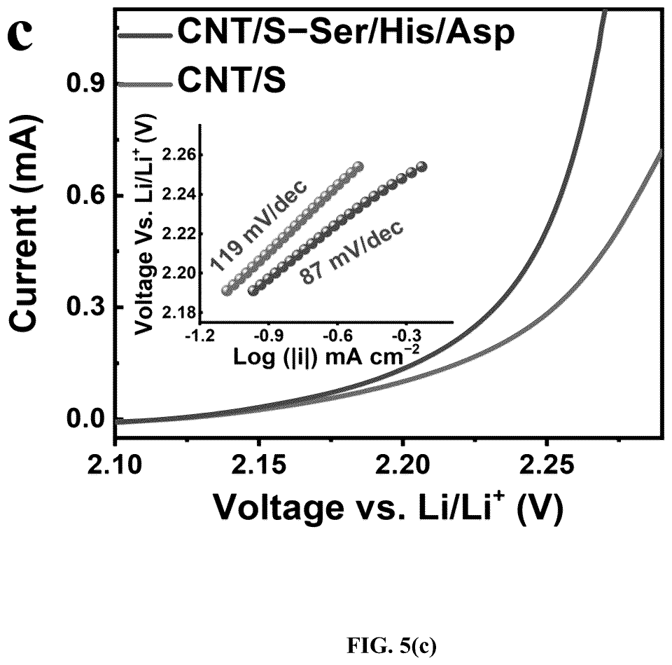

In order to more specifically analyze the catalytic ability of Ser-His-Asp, the Tafel slopes of Peak i (S& converts to long-chain and medium-chain polysulfides, 2.28V), Peak ii (from long-chain and medium-chain polysulfides to short-chain polysulfides, 2.05V) and Peak iii (from Li₂S to long-chain polysulfide, 2.4V) in FIG. 2 are calculated. During the reduction process, the Tafel slope of CNT/S-Ser/His/Asp cathode (Peak i: 46 mV dec⁻¹; peak ii: 37 mV dec⁻¹) is significantly lower than that of CNT/S cathode (Peak i: 55 mV December 1; peakii: 87 mV dec⁻¹); during the oxidation process, the Tafel slope of the CNT/S-Ser/His/Asp cathode is also better than that of the CNT/S cathode (CNT/S-Ser/His/Asp: 87 mV dec⁻¹; CNT/S: 119 mV dec⁻¹) (see FIG. 5). This indicates that the Ser-His-Asp catalyst exhibits bi-directional catalytic activity for lithium-sulfur battery, which helps to promote the redox conversion between polysulfide and Li₂S.

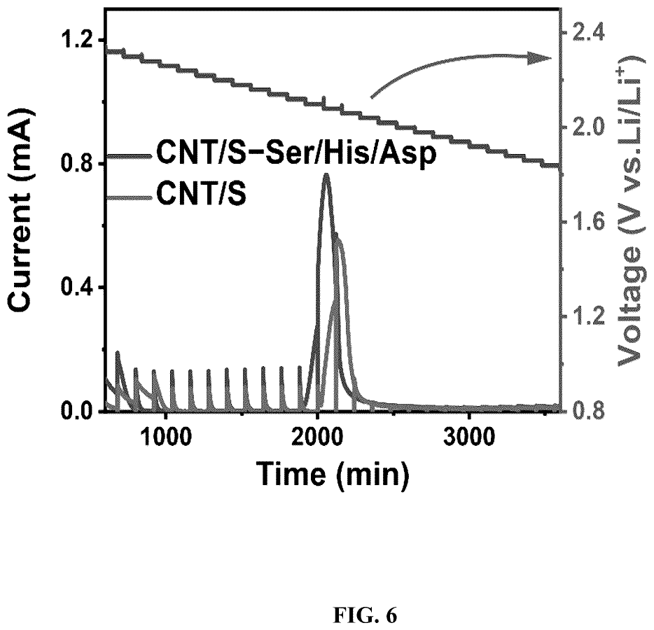

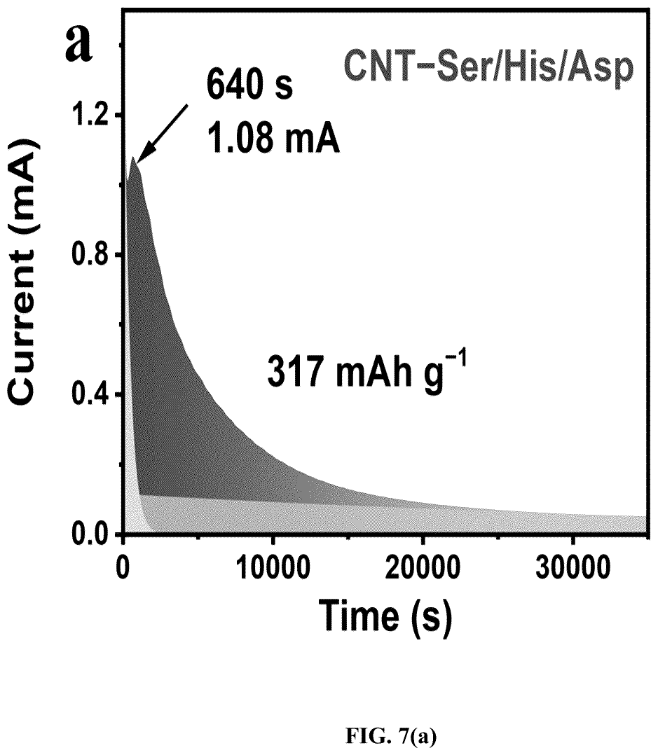

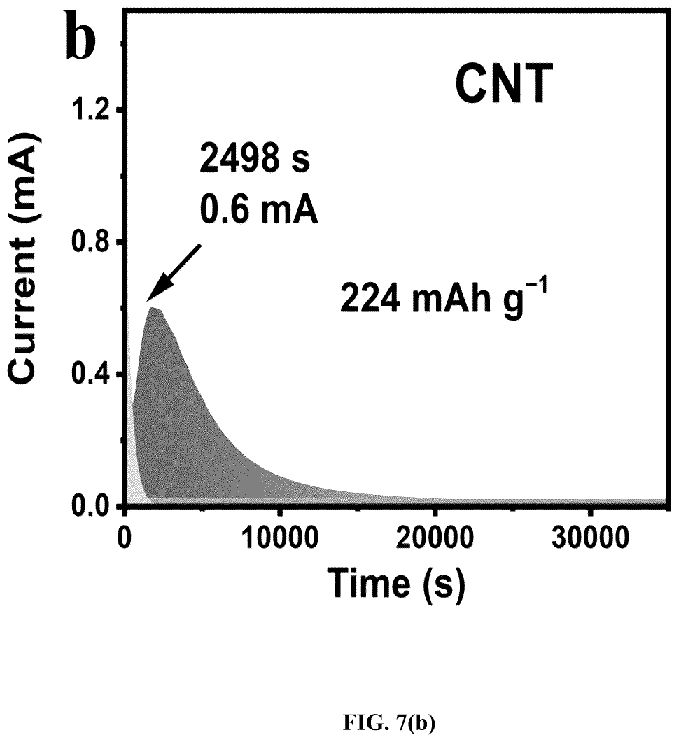

The same result is also verified by PITT. As shown in FIG. 6, the peak current of CNT/S-Ser/His/Asp cathode appears at 2050 min, and the peak current is 0.78 mA. The peak current of CNT/S cathode appears at 2200 min, and the peak current is 0.56 mA. Compared with CNT/S cathode, CNT/S-Ser/His/Asp cathode has a faster and higher peak current, indicating that CNT/S-Ser/His/Asp cathode can effectively catalyze polysulfide. The Li₂S deposition experiment is also carried out, as shown in FIG. 7, the peak current of CNT-Ser/His/Asp cathode appears at 640s, and the peak current is 1.08 mA, which is better than the deposition rate and response current of CNT cathode (2498s and 0.6 mA). In addition, the Li₂S deposition capacity of CNT-Ser/His/Asp cathode is 317 mAh g⁻¹, which is larger than that of CNT cathode (224 mAh g⁻¹), indicating that CNT-Ser/His/Asp cathode promotes the liquid-solid reaction of lithium-sulfur battery.

2. Analysis of the Microscopic Mechanism of Surface Sulfur Conversion Based on in-Situ Spectra.

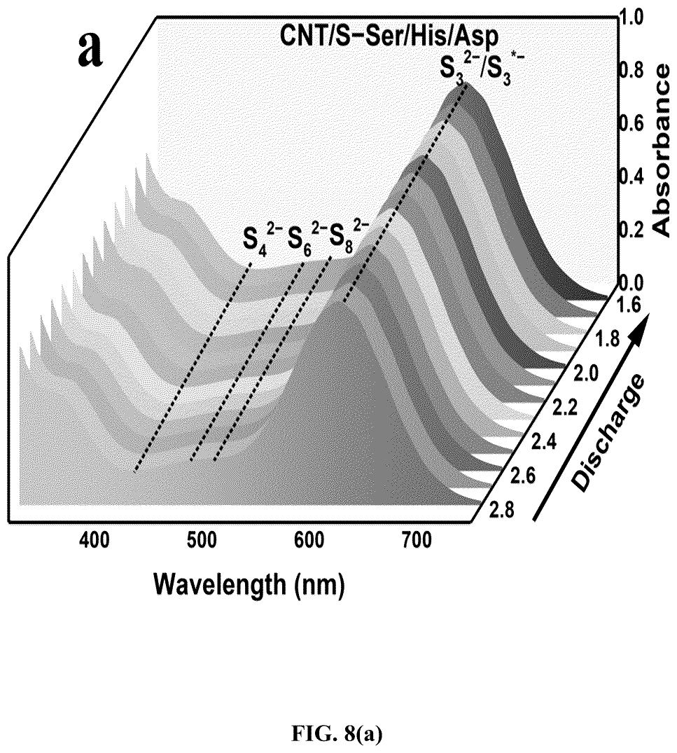

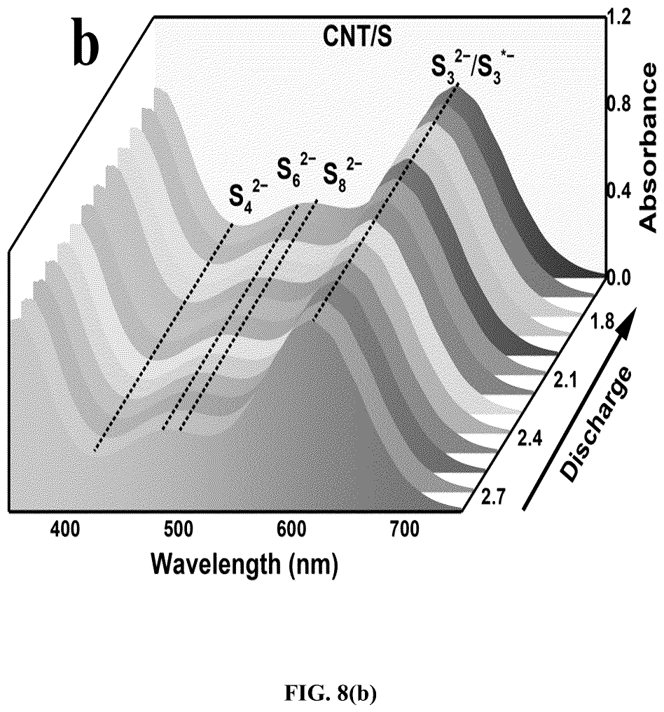

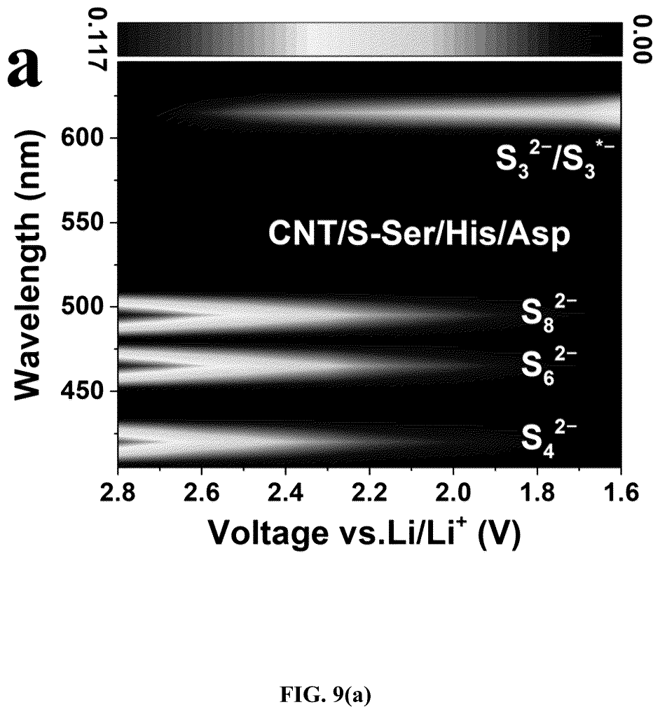

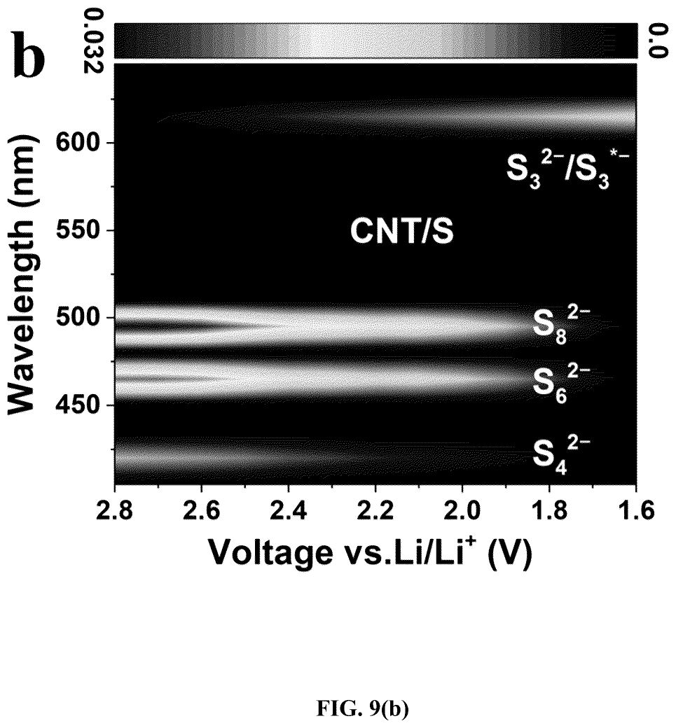

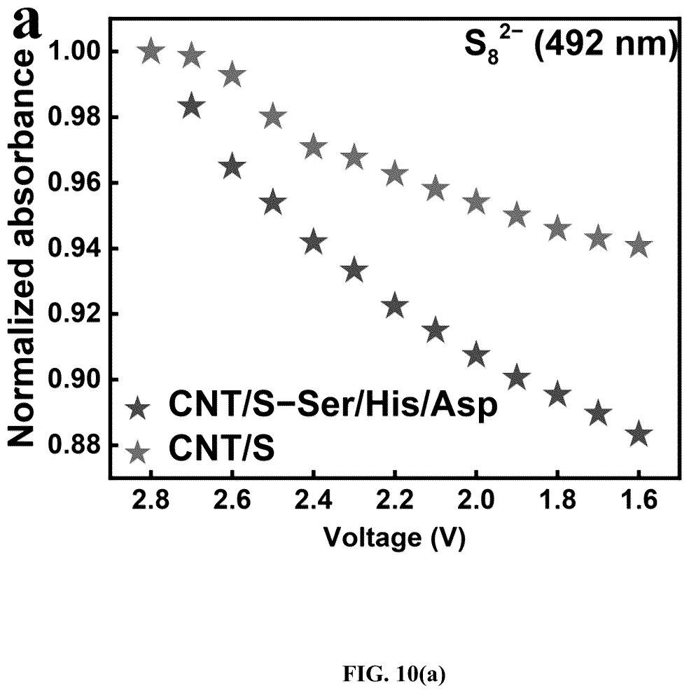

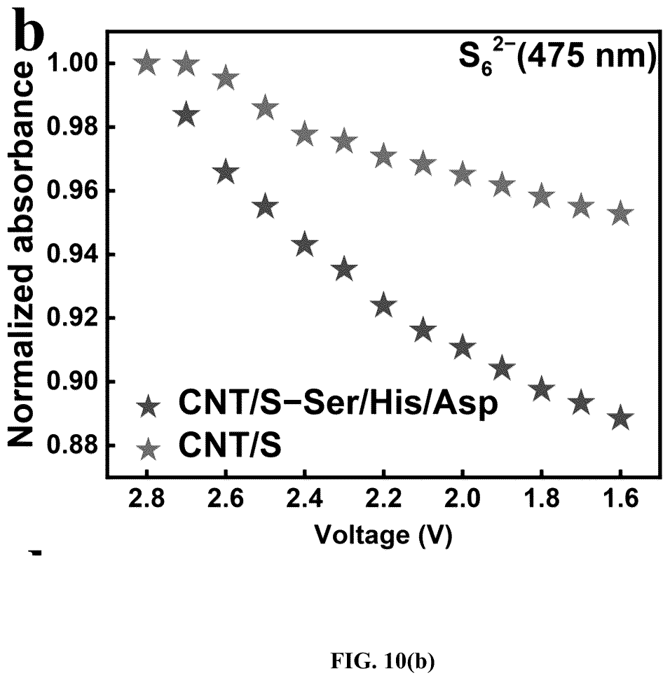

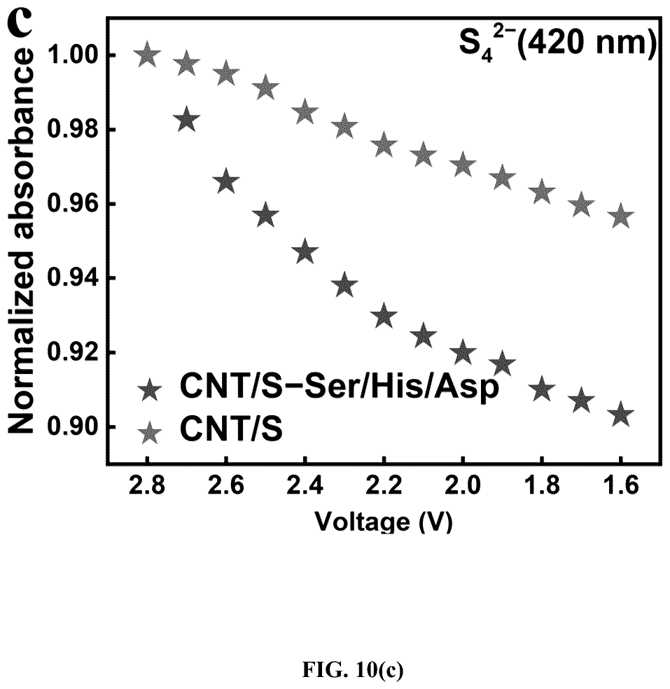

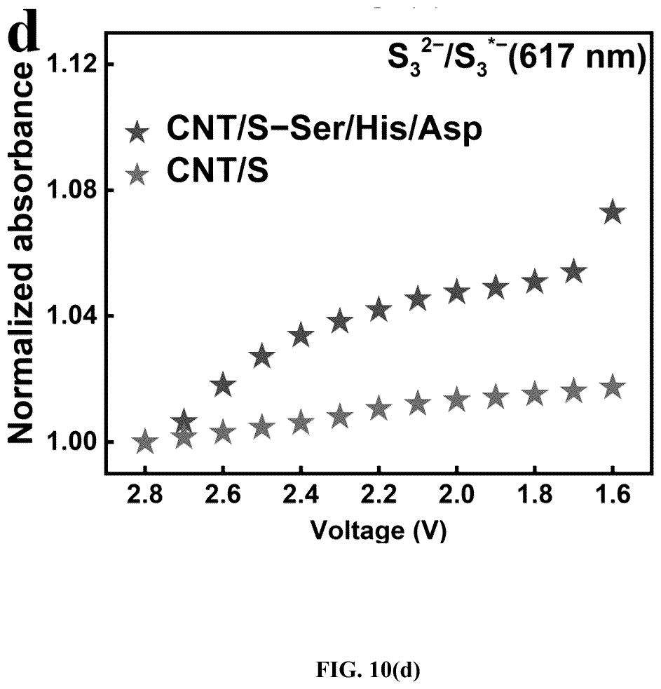

In order to quantitatively measure the catalytic effect of Ser-His-Asp, in situ UV-Vis absorption spectra (UV-Vis) is used to evaluate the change of sulfur species on the surface of CNT/S-Ser/His/Asp and CNT/S cathodes during discharge. FIG. 8 shows the UV-Vis spectra of CNT/S-Ser/His/Asp and CNT/S cathode surfaces from 2.8 to 1.6V, wherein the reaction intermediate comprises S₈²⁻ (492 nm), S₆²⁻ (475 nm), S₄²⁻ (420 nm) and S₃²⁻/S₃*⁻ (617 nm). The contour map of UV-Vis absorption spectra of CNT/S-Ser/His/Asp and CNT/S cathodes during discharge in Li₂S₈ solution is drawn (see FIG. 9). In addition, the absorption intensities of S₈²⁻ (492 nm), S₆²⁻ (475 nm), S₄²⁻ (420 nm) and S₃²⁻/S₃*⁻ (617 nm) are normalized, and the change diagram of the concentrations of the four reaction intermediates during the discharge process is drawn (see FIG. 10). It can be clearly observed that in the range of 2.8-2.4V, the absorbance of S₈²⁻, S₆²⁻ and S₄²⁻ of CNT/S-Ser/His/Asp cathode decreases rapidly (see FIG. 10a˜c), and the absorbance of S₃²⁻/S₃*⁻ continues to increase (see FIG. 10d), which is related to the reduction of long-chain polysulfides, at the same time, as the consumption of S₃²⁻/S₃*⁻ is further converted into solid phase Li₂S₂ and Li₂S, the increase of S₃²⁻/S₃*⁻ concentration is slowed down. Relatively speaking, the transition of sulfur species in CNT/S cathode is relatively slow during the whole discharge process. At the beginning and end of the discharge, the conversion of S₈²⁻, S₆²⁻ and S₄²⁻ and the formation rate of S₃²⁻/S₃*⁻ are lower than those of CNT/S-Ser/His/Asp cathode (see FIG. 10). It is worth noting that only the slow conversion of CNT/S cathode S₈²⁻ to S₃²⁻/S₃*⁻ is observed in FIG. 3-FIG. 10d. These results indicate that the CNT/S-Ser/His/Asp cathode can promote the conversion of long-chain and short-chain polysulfides, thereby comprehensively improving the liquid-liquid and liquid-solid conversion reaction kinetics of lithium-sulfur battery.

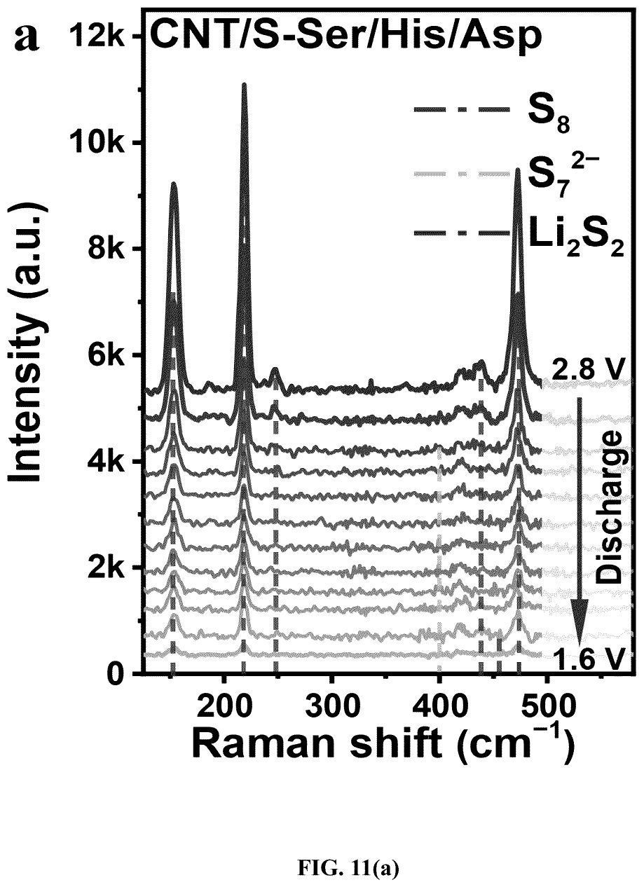

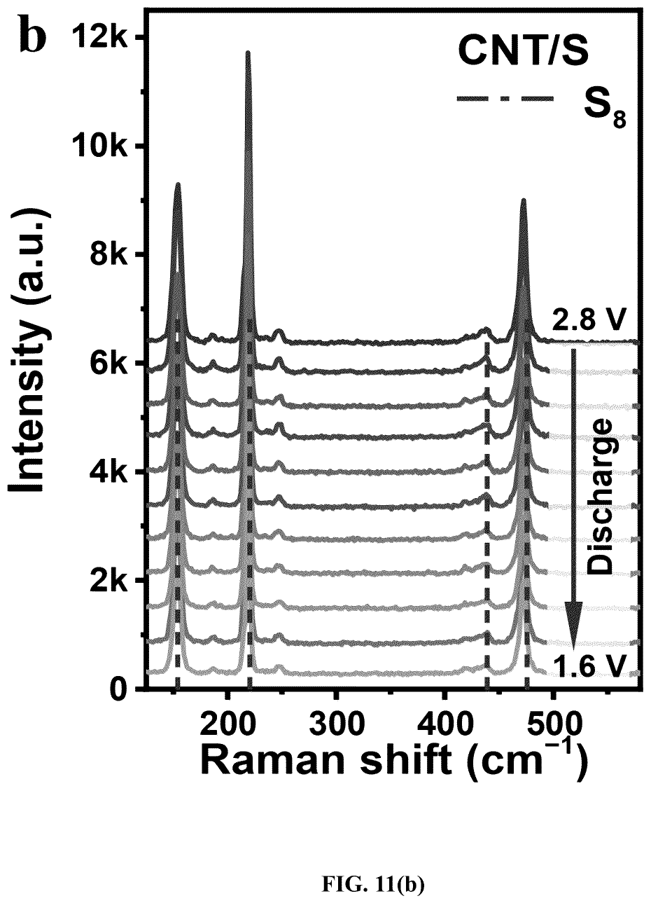

In-situ Raman spectra can be used to monitor the sulfur substance produced by the electrode during charge and discharge. In order to deeply analyze the catalytic mechanism of Ser-His-Asp on sulfur conversion, the in-situ Raman spectra of CNT/S-Ser/His/Asp and CNT/S cathodes during discharge are tested. As shown in FIG. 11, four characteristic peaks of S₈ (150,219,437 and 474 cm⁻¹) can be observed when both CNT/S-Ser/His/Asp and CNT/S cathodes at 2.8V (see FIG. 11). As the discharge progresses, the CNT/S cathode still has an obvious S₈ signal at the end of the discharge (see FIG. 3-11b), in contrast, the S₈ signal of the CNT/S-Ser/His/Asp cathode almost completely disappears after the discharge (see FIG. 11a). At the same time, the intermediate product signals of S₇²⁻ (400 cm⁻¹) and Li₂S (450 cm⁻¹) of CNT/S-Ser/His/Asp cathode are observed at the voltages of 2.6V and 1.7V. (FIG. 11a), indicating that the CNT/S-Ser/His/Asp cathode catalyzes the conversion of S₈ to S₇²⁻ and finally to Li₂S in a short time. The results show that the CNT/S-Ser/His/Asp cathode has higher conversion efficiency for polysulfide.

### 3. Battery Performance.

The battery assembly method is as follows: the CR2025 coin cell is assembled by the cathode (which is selected from the cathode prepared by the above Embodiment 1 and the Ratio 1, respectively), the lithium anode, the separator and the lithium-sulfur electrolyte in a glove box filled with inert gas (<0.1 ppm O₂, H₂O). The cathode surface density is controlled at 0.8 mg cm⁻², and the electrolyte/sulfur (E/S) is controlled at ˜20 μL mg⁻¹; the cathode surface density of the high sulfur loading test is controlled at about 4 mg cm⁻²; the cathode density of the lean electrolyte test is controlled at 4 mg cm⁻² and the electrolyte/sulfur (E/S) ratio is controlled at about 10 μL mg⁻¹. CV test and electrochemical impedance spectroscopy (EIS) test are carried out at room temperature by using CHI760E workstation. The rate and long cycle performance of the 1.6˜2.8V voltage range are recorded by using the new battery cabinet at a constant temperature of 30° C.

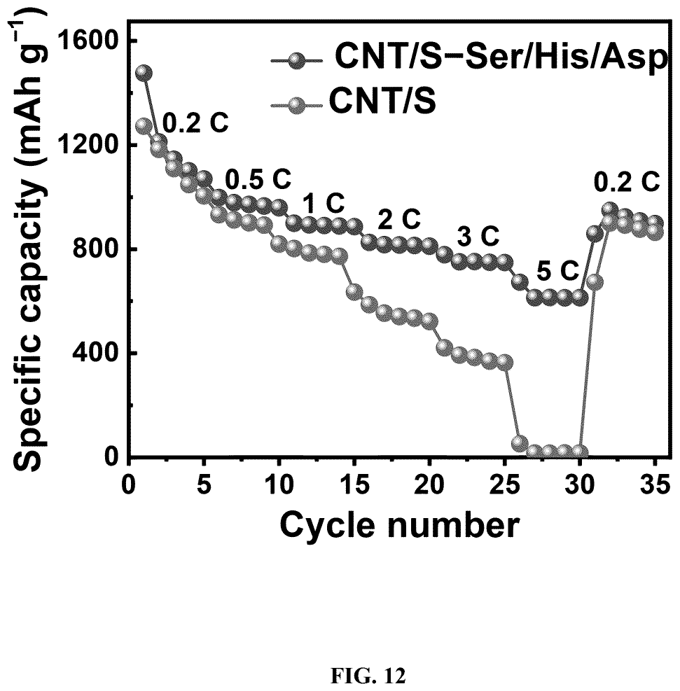

As shown in FIG. 12, the CNT/S-Ser/His/Asp cathode has a discharge specific capacity of 1467,998,899,826 and 778 mAh g⁻¹ at rates of 0.2,0.5,1,2 and 3 C, respectively, when the current density is increased to 5 C, there is still a discharge specific capacity of 672 mAh g⁻¹. The discharge specific capacities of CNT/S cathode at 0.2,0.5,1,2,3 and 5 C are only 1272,932,819,634,420 and 52 mAh g⁻¹, respectively. More importantly, when the rate is switched back to 0.2 C, the discharge specific capacity of the CNT/S-Ser/His/Asp cathode can be restored to 949 mAh g⁻¹. The results show that the CNT/S-Ser/His/Asp cathode not only has better rate capability, but also can maintain the stability of the structure after different rate cycles, and it has good reversibility.

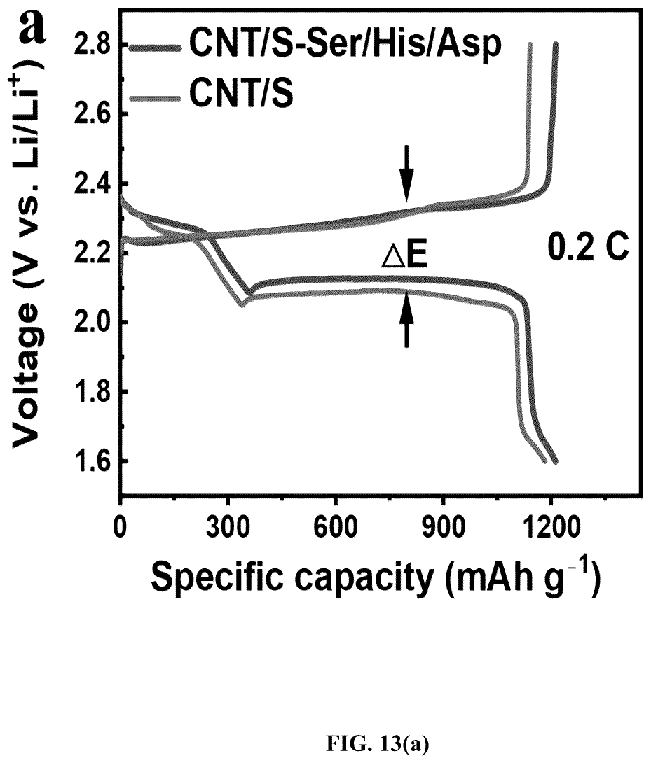

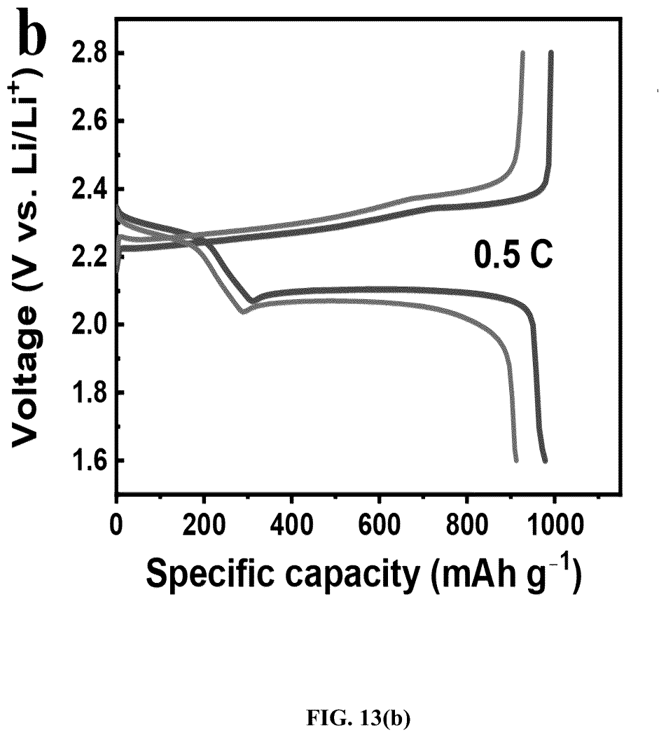

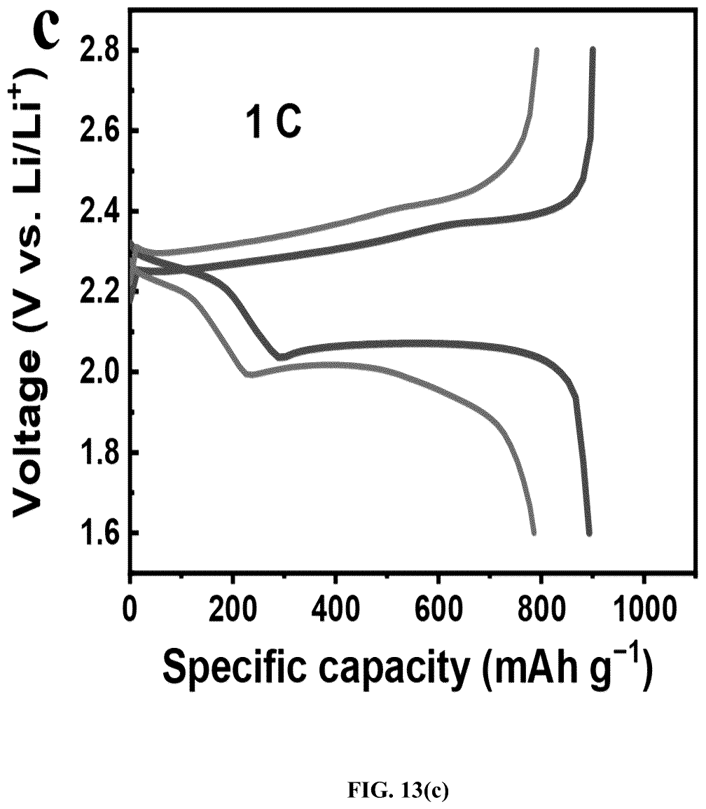

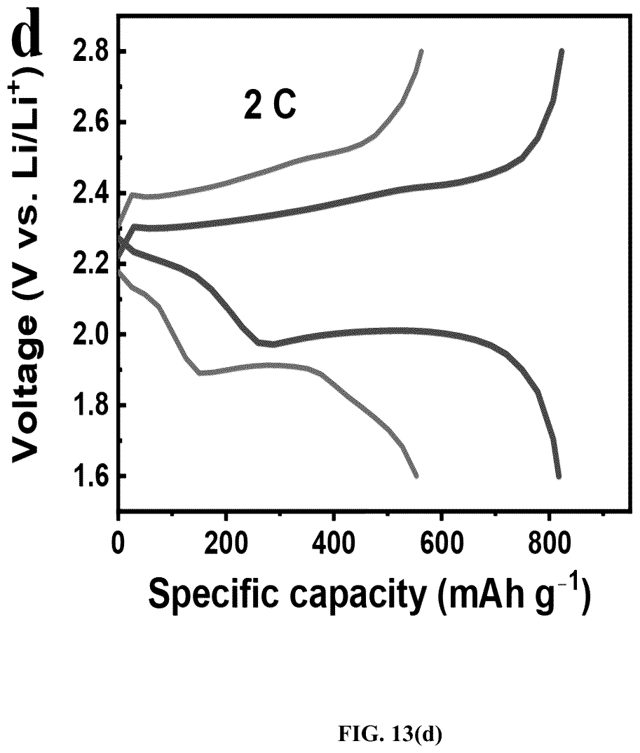

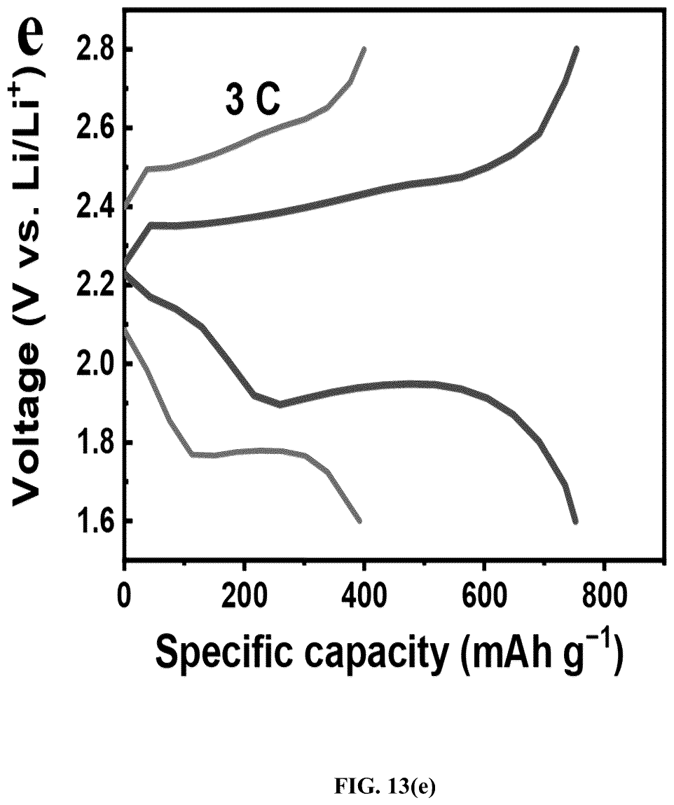

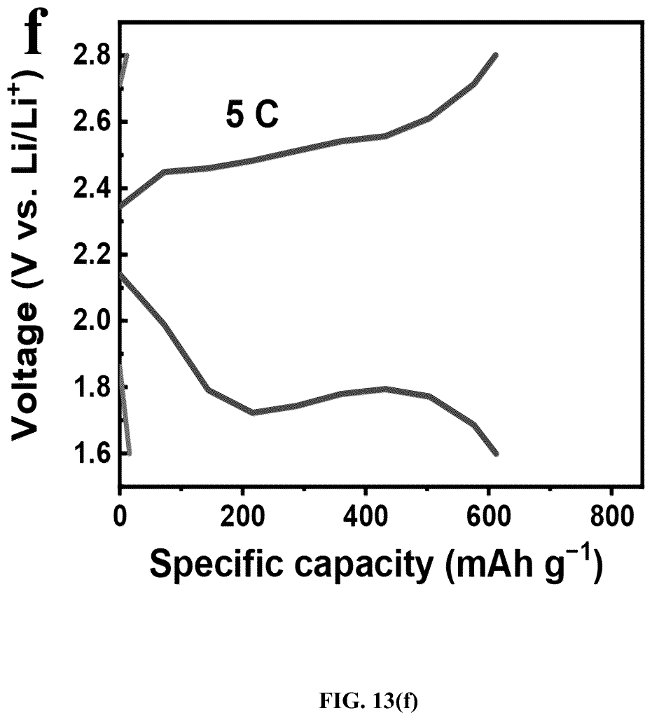

The charge/discharge curves of the second cycle of CNT/S-Ser/His/Asp cathode and CNT/S cathode at 0.2 C are further analyzed in detail (see FIG. 13 a). It can be seen that during the discharge process, a platform appears at 2.3V and 2.1V, respectively, which can be attributed to the reduction reaction from S₈ to long-chain polysulfide to short-chain polysulfide and finally to Li₂S; a charging platform appears during the charging process, which is attributed to the reversible conversion of Li₂S to long-chain polysulfide and then to S₈, which is completely consistent with the CV curve. At the same time, the comparison of the charge/discharge voltage curves of the CNT/S-Ser/His/Asp cathode and the CNT/S cathode at 0.2, 0.5, 1, 2, 3 and 5 C further confirms that the CNT/S-Ser/His/Asp cathode has better electrochemical kinetics (see FIG. 13a˜f) and smaller polarization voltage (ΔE), which is consistent with the previous results (see FIG. 4).

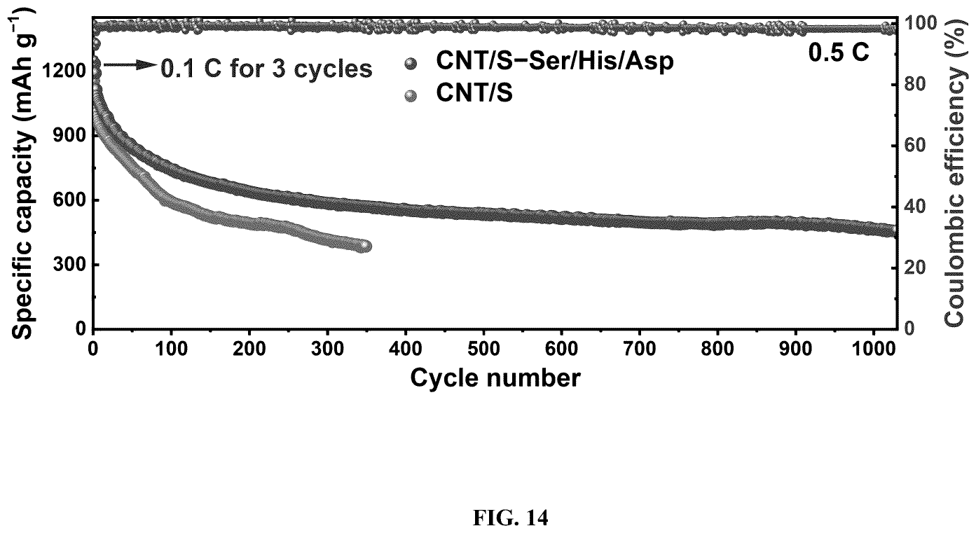

In addition, the long cycle performance of the battery is evaluated. As shown in FIG. 14, the initial discharge specific capacity of the CNT/S-Ser/His/Asp cathode exceeds 1114 mAh g⁻¹ at a rate of 0.5 C, after 1030 cycles, the specific capacity can be stably maintained above 460 mAh g⁻¹, which accounts for 42% of the initial discharge specific capacity, and the capacity decay rate of a single cycle is only 0.057%. Although the initial discharge specific capacity of the CNT/S cathode at 0.5 C is 1003 mAh g⁻¹, it can only cycle for 348 cycles, with a retention rate of only 38%, the capacity decay rate of a single cycle is as high as 0.18%, and the average coulombic efficiency is lower than that of the CNT/S-Ser/His/Asp cathode through the whole cycle. These results indicate that the CNT/S-Ser/His/Asp cathode promotes the conversion of polysulfide and improves the long cycle performance of lithium-sulfur battery.

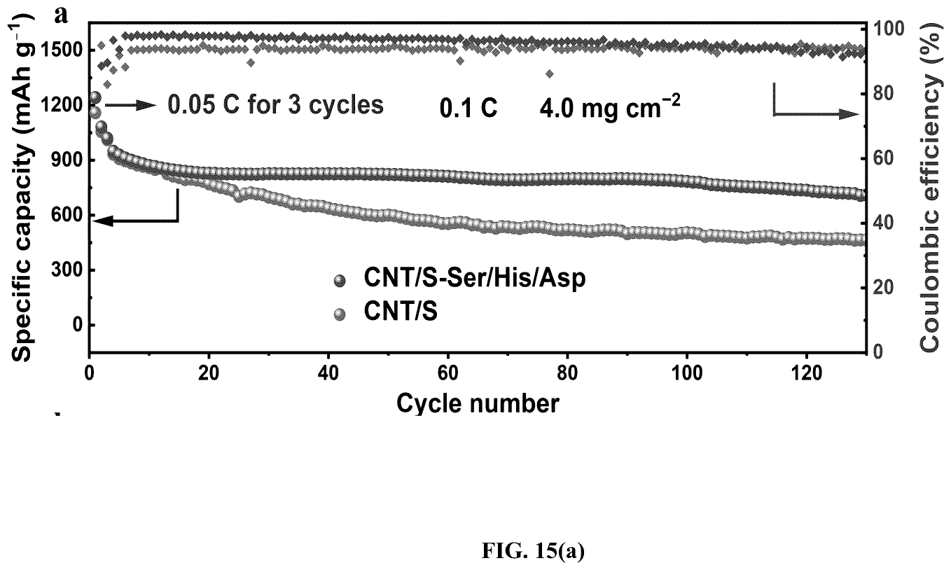

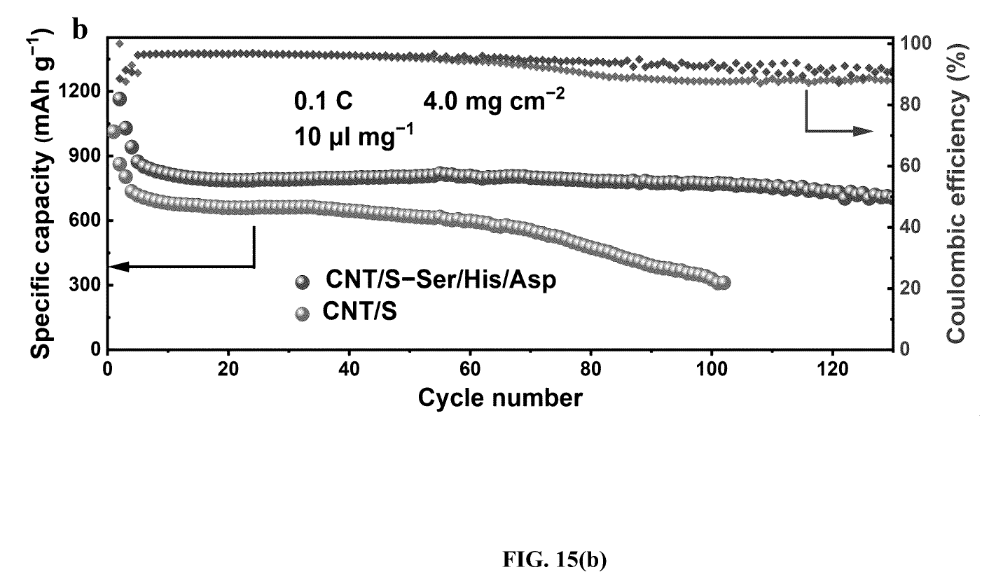

In addition, the industrialization potential of CNT/S-Ser/His/Asp cathode lithium-sulfur battery is also evaluated, as shown in FIG. 15a, when the sulfur loading of CNT/S-Ser/His/Asp cathode is increased to 4 mg cm⁻², the initial discharge specific capacity at 0.1 C is 949 mAh g⁻¹, and there is still a discharge specific capacity of 709 mAh g⁻¹ after 130 cycles. Although the initial discharge specific capacity of the CNT/S cathode is similar to that of the CNT/S-Ser/His/Asp cathode, only 480 mAh g⁻¹ remains after 130 cycles. Further test is carried out under more stringent condition (sulfur loading of electrode is 4 mg cm⁻², E/S ratio is 10 Lmg⁻¹). As shown in FIG. 15b, the CNT/S-Ser/His/Asp cathode still maintains an initial discharge specific capacity which is up to 1165 mAh g⁻¹ at 0.1 C, and it can successfully cycle for 130 cycles, and the decay rate of a single cycle is only 0.14%, while the CNT/S cathode can only cycle for 100 cycles. The results show that the CNT/S-Ser/His/Asp cathode has excellent long cycle performance under harsh condition.

### 4. The Effect of Catalytic Triad on Polysulfide.

In order to better understand the regulatory mechanism of the three amino acids in the whole sulfur conversion process, the interaction between these three amino acids and polysulfide is studied from the aspects of adsorption, catalytic conversion and electron/ion conduction.

### (1) Adsorption.

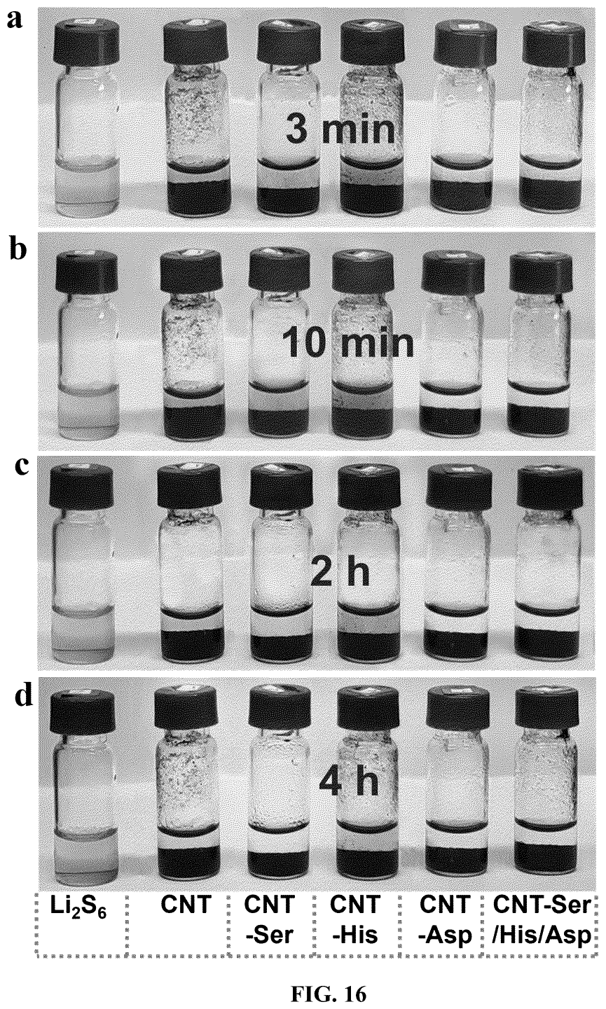

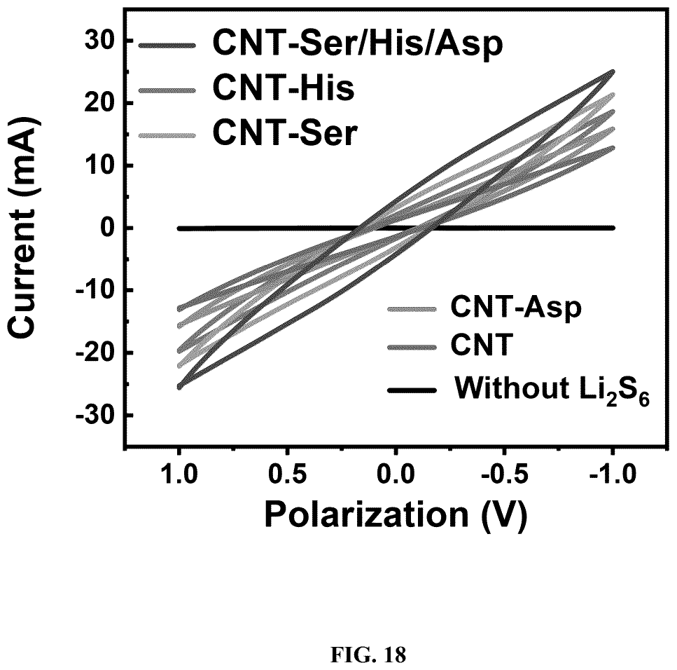

Firstly, the ability of three amino acids (Ser, His and Asp) to adsorb polysulfide is investigated by Li₂S₆ static adsorption experiment. 0.6 mL of Li₂S₆ solution (2 mmol L⁻¹) is used as a reference, and 10 mg of CNT, CNT-Ser, CNT-His, CNT-Asp and CNT-Ser/His/Asp are added to the Li₂S₆ solution to observe the color change. As shown in the optical image (see FIG. 16), the Li₂S₆ solution containing CNT-Asp and CNT-Ser/His/Asp is instantly transformed into a colorless transparent state; the Li₂S₆ solution added with CNT-Ser gradually becomes lighter with time until it becomes completely transparent after 4h. However, the Li₂S₆ solution added with CNT-His has almost no color change after 4h, indicating that the adsorption effect of Asp component on Li₂S₆ is more obvious than that of Ser and His. The effect of Ser on Li₂S₆ may be due to its ability to shear polysulfide, which is as evidenced by symmetrical battery test (see FIG. 18).

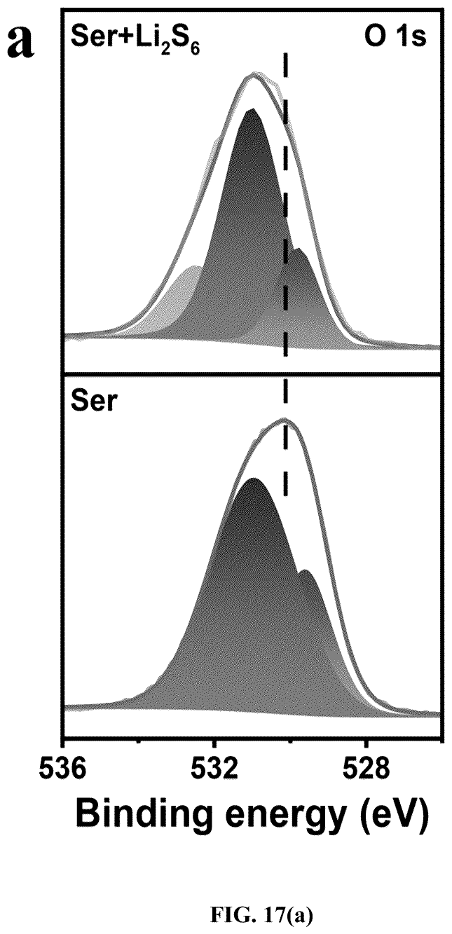

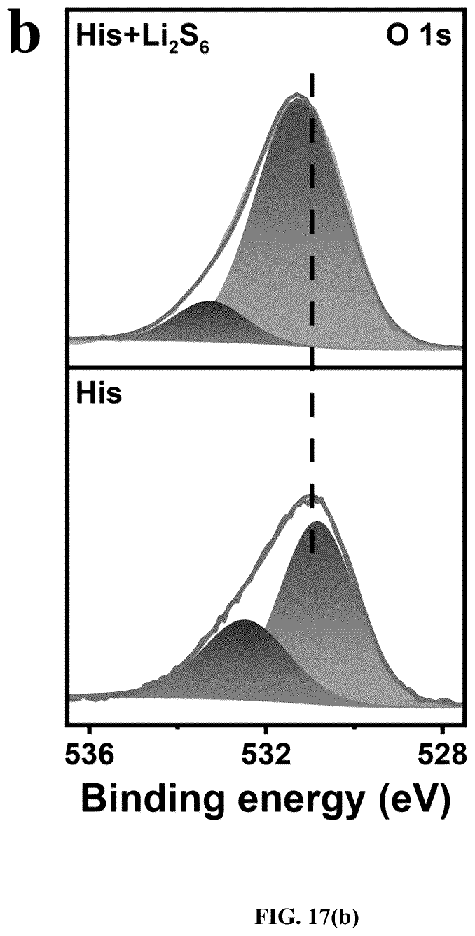

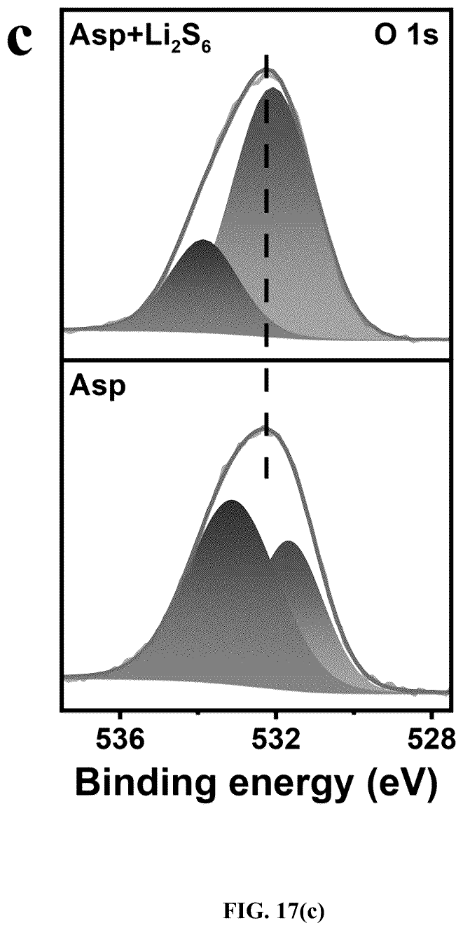

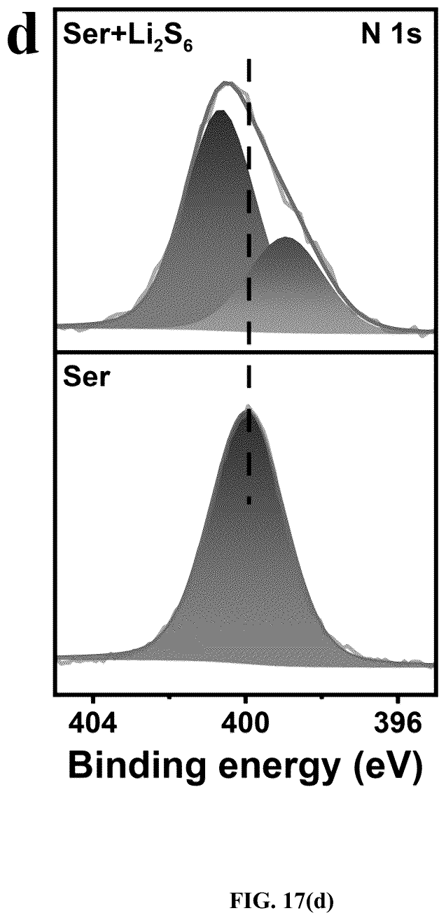

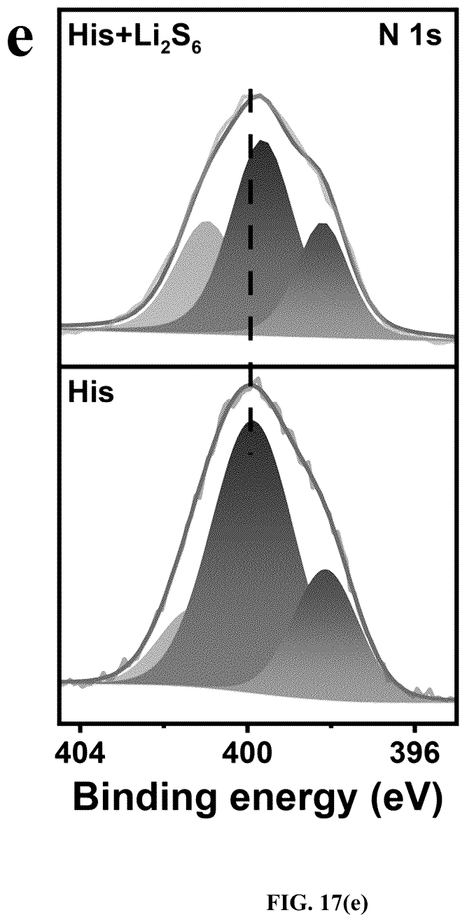

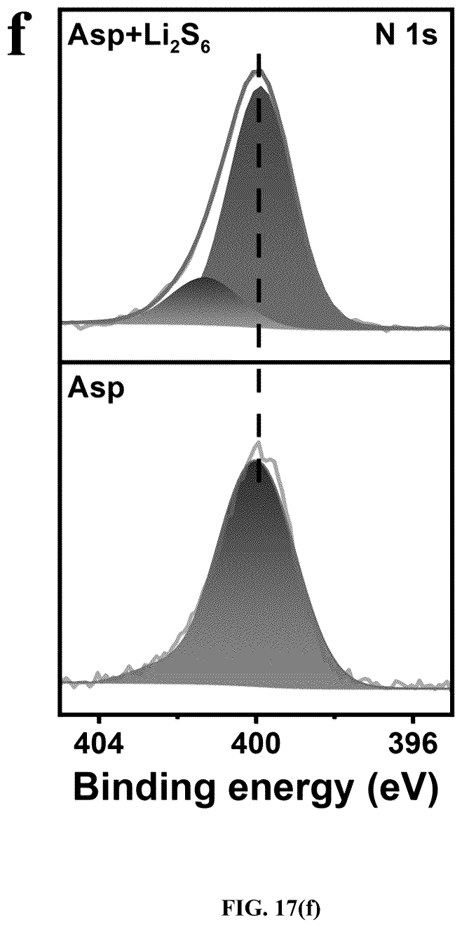

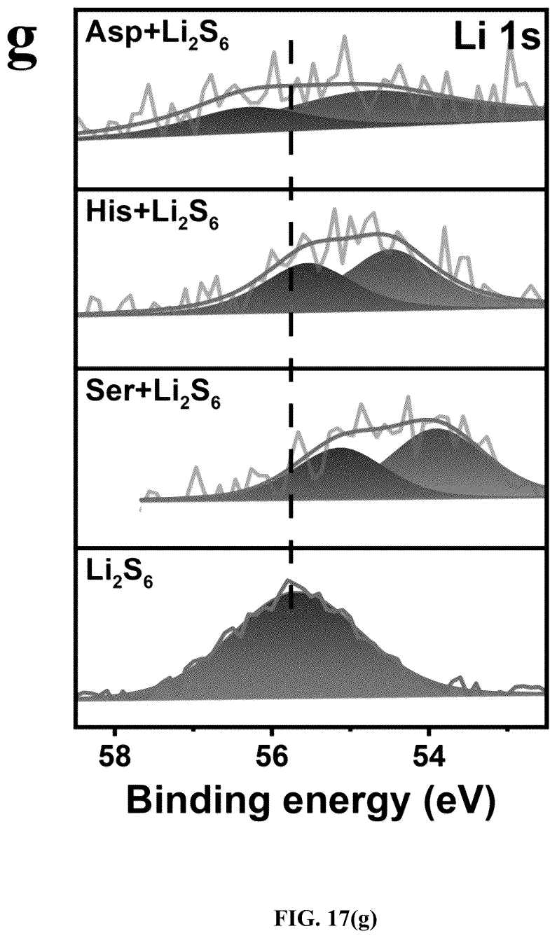

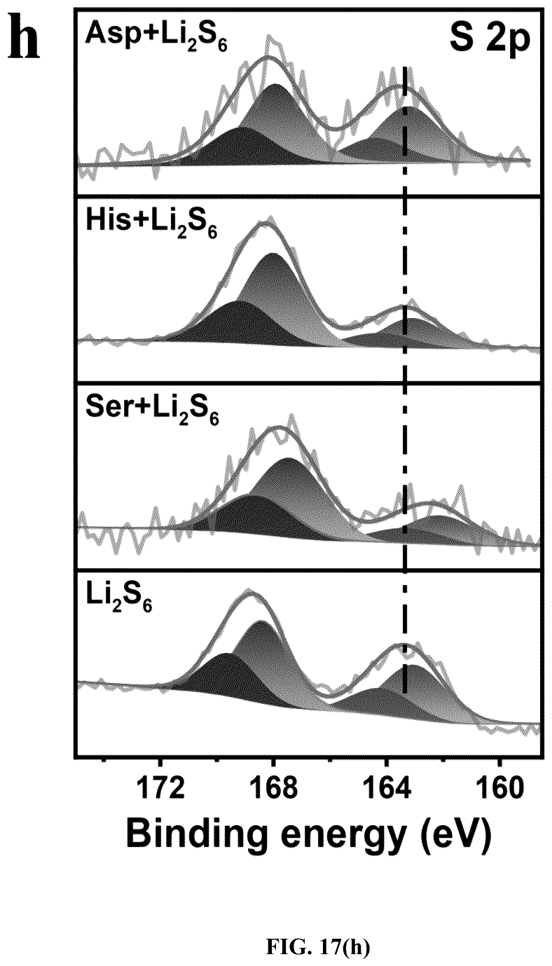

In addition, X-ray photoelectron spectra (XPS) analysis is performed on the materials (CNT-Ser, CNT-His, CNT-Asp) before and after adsorption of Li₂S₆ solution (see FIG. 17). From the O 1s, N Is, Li 1s and S 2p spectra of the three amino acids (Ser, His and Asp), it can be seen that after Ser adsorbs Li₂S₆, the peaks of O 1s and N 1s spectra move to higher binding energy, and the peaks of Li 1s and S 2p spectra move to lower binding energy. This indicates that the O and N atoms in Ser and the S or Li atoms in Li₂S₆ have formed relatively strong chemical bond. The O atom in Ser provides electron to Li⁺ or S atoms, so the binding energy of the O 1s spectra increases, the formation of Li—N may involve the transfer of electron from the N atom in Ser to Li⁺, so the binding energy of the N 1s spectra increases.

After the adsorption of Li₂S₆ by His, the peaks of O 1s and N 1s spectra also move to higher binding energy, and the peaks of Li 1s and S 2p spectra also move to lower binding energy. Although the peak shift is weaker than that of Ser, it also indicates that His forms a certain degree of chemical bond with Li atom in Li₂S₆, thus providing a Li⁺ transport channel.

After the adsorption of Li₂S₆ by Asp, the peaks of O 1s, N 1s, Li 1s and S 2p spectra have no obvious shift, indicating that the binding of Asp to polysulfide is not a chemical binding, but a physical adsorption. Its superior adsorption performance may be due to the fact that Asp has two negatively charged carboxyl functional groups, which is conducive to forming a strong electrostatic attraction with polysulfide, this interaction also makes polysulfide more vulnerable to the attack of nucleophile Ser.

### (2) Catalytic Conversion of Polysulfide.

In order to further understand the mechanism of Ser, His and Asp promoting sulfur conversion at the cathode of lithium-sulfur battery, symmetrical battery test is carried out by using CHI760E electrochemical workstation. As shown in FIG. 18, the peak current densities of the CV curves of the electrodes containing Ser component (CNT-Ser/His/Asp and CNT-Ser) are 23 and 19 mA, respectively, and the current densities of the electrodes without Ser component (CNT-His, CNT-Asp and CNT) are 16, 14 and 10 mA, respectively. The results show that the peak current density of the electrode with Ser component is higher than that of the electrode without Ser component. It is indicated that Ser can shear the S—S bond to a certain extent and improve the conversion kinetics of polysulfide in liquid phase, attributing to the nucleophilic attack ability of Ser hydroxyl group, which is easier to break the S—S bond by deprotonation and promote the conversion of polysulfide. At the same time, in the XPS results before and after the adsorption of Li₂S₆ solution (see FIG. 17), it also confirms from the side that soluble polysulfide may spontaneously catalyze and transform on the Ser surface, the reason is that compared with Aps and His, the Ser surface conducts more electron exchange through Li—N and S—O bonds (shown as a larger XPS peak shift).

### (3) Electron/Ion Transmission.

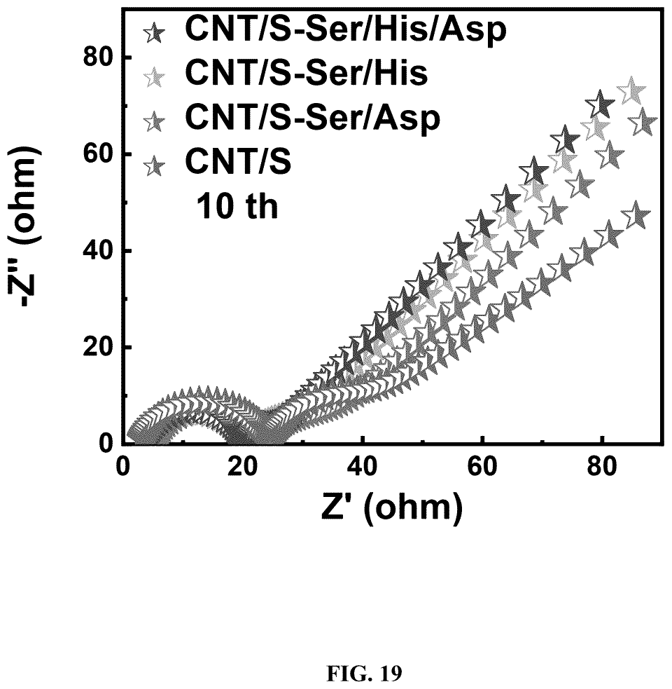

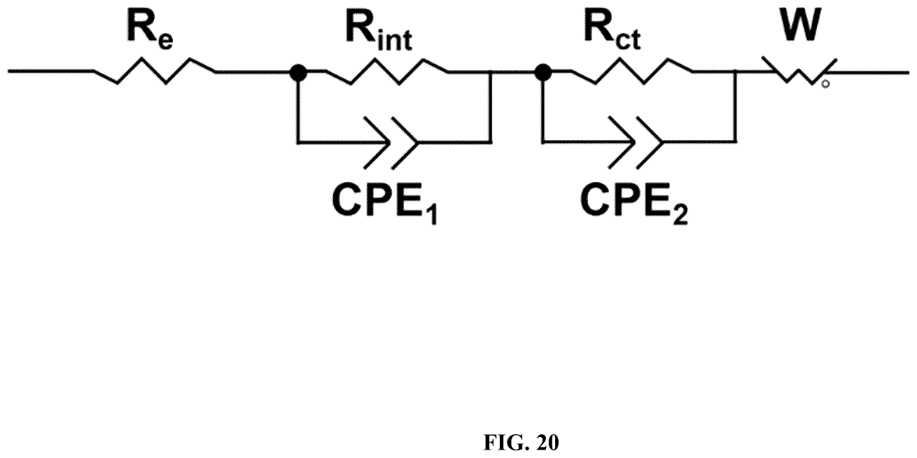

In addition to adsorption and catalysis, the transmission characteristic of electron and ion also play a crucial role in the conversion of polysulfide. For this reason, the EIS spectra of CNT/S-Ser/His/Asp, CNT/S-Ser/His, CNT/S-Ser/Asp and CNT/S cathodes after 10 cycles are first tested. As shown in FIG. 19, after 10 cycles, there are two concave semicircles in the spectra of each material. The semicircle in the high frequency region is related to the formation of the solid electrolyte interface layer on the electrode surface, while the semicircle in the intermediate frequency region corresponds to the charge transfer process and its double layer capacitance. In order to analyze the AC impedance spectra of the sulfur composite cathode, the equivalent circuit shown in FIG. 20 is used to fit the spectra. In the equivalent circuit, Re is the solution resistance, Rᵢₙₜ is the surface layer resistance, R_{ct} is the charge transfer resistance of the electrochemical reaction, and W is the Warburg impedance. In the low frequency region, the impedance is usually linear, which forms a Warburg slope. The Warburg slope is related to the Li⁺ diffusion process, and its expression is Z=A*ω^{(-0.5)}, wherein Z is the impedance, A is the Warburg coefficient, and o is the angular frequency. The Li⁺ diffusion coefficients (D_{Li}⁺) of CNT/S-Ser/His/Asp, CNT/S-Ser/His, CNT/S-Ser/Asp and CNT/S cathodes are calculated by formula:

$$D = 0.5 {( \frac{RT}{{AF}^{2} {σ}_{w} C} )}^{2}$$

Wherein R is the gas constant, Tis the absolute temperature, A is the electrode surface area, F is the Faraday constant, C is the molar concentration of Li⁺, and σ_{w} is the Warburg coefficient.

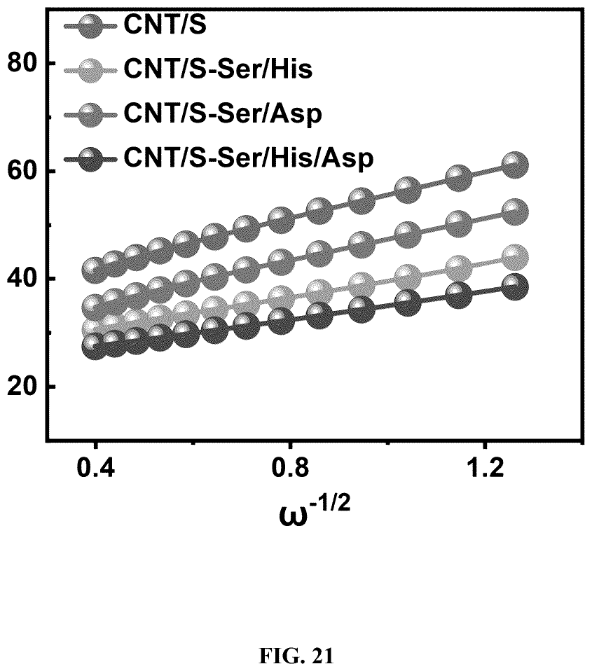

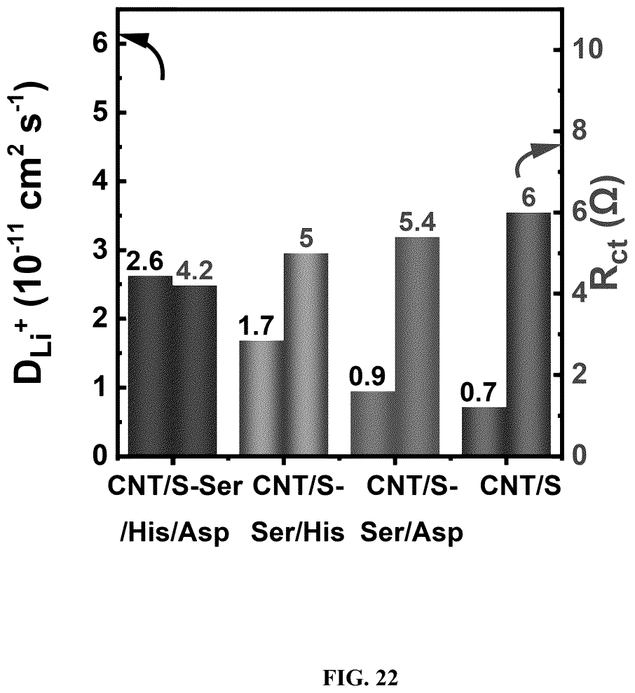

The relationship between the Zⁿ of CNT/S-Ser/His/Asp, CNT/S-Ser/His, CNT/S-Ser/Asp and CNT/S cathodes and the reciprocal square root of the lower angular frequency (ω^{-1/2}) is shown in FIG. 21. The slope of the fitting line is σ_{w}. The R_{ct} values of CNT/S-Ser/His/Asp, CNT/S-Ser/His, CNT/S-Ser/Asp and CNT/S cathodes after 10 cycles are 4.2,5,5.4 and 6Ω, respectively, the calculated Li⁺ diffusion coefficients are 2.6×10⁻¹¹,1.7×10⁻¹¹,0.9×10⁻¹¹ and 0.7×10⁻¹¹ cm² s⁻¹, respectively (see FIG. 22). The results show that the electrode containing His has larger D_{Li}⁺ and smaller Ret than other electrodes, which clearly proves the beneficial effect of adding His on enhancing the electron and ion conductivity of the electrode/electrolyte interface.

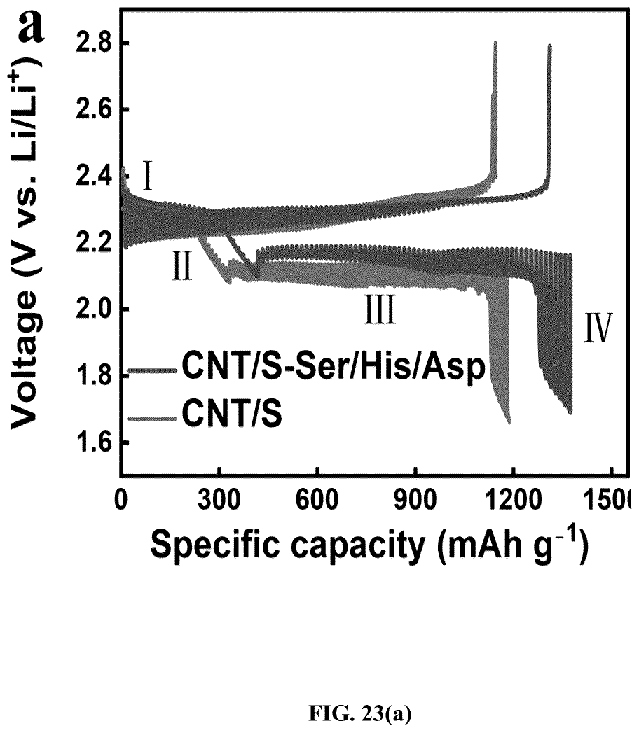

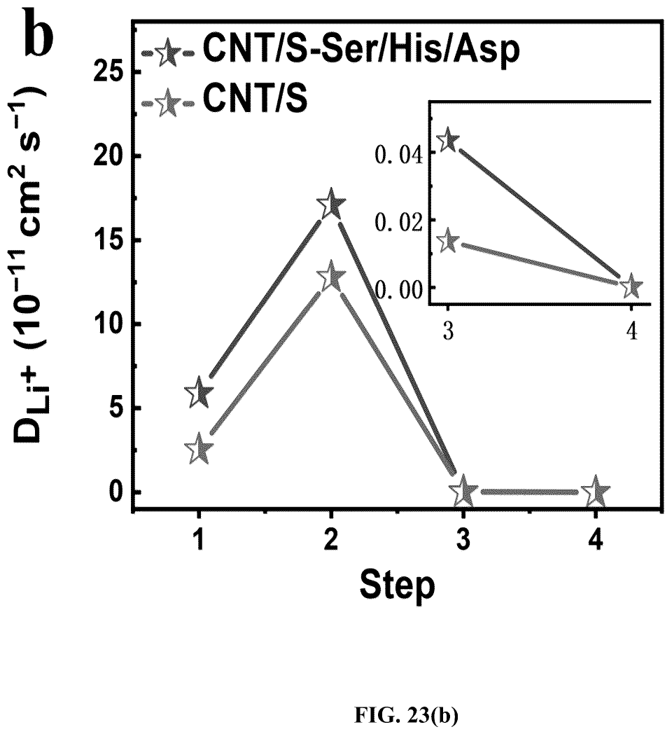

In addition to the EIS test, the Li⁺ diffusion coefficient is calculated by GITT. From FIG. 23a, it can be seen that compared with CNT/S cathode, CNT/S-Ser/His/Asp cathode has a longer charge/discharge platform under the GITT curve and a smaller voltage fluctuation, especially the third discharge platform from liquid Li₂S₄ to solid Li₂S₂/Li₂S. The Li⁺ diffusion coefficient (D_{Li}⁺) of the battery is calculated according to Fick's second law:

$${D}_{{Li}^{+}} = \frac{4}{πτ} {( \frac{{m}_{B} {V}_{M}}{{M}_{B} A} )}^{2} {( \frac{Δ {E}_{s}}{Δ {E}_{τ}} )}^{2}$$

Wherein m_{B}, V_{M} and M_{B} are the mass, molar volume and molecular weight of the active substance, respectively; t is the duration of the current pulse (600s), A is the surface area of the active material, AEs is the voltage change caused by the pulse, and ΔEₜ is the voltage change of the constant current charge and discharge.

As shown in FIG. 23b, the Li⁺ diffusion coefficient of CNT/S-Ser/His/Asp cathode is superior to that of CNT/S cathode in Steps I, II, III and IV, indicating that CNT/S-Ser/His/Asp cathode promotes Li⁺ diffusion through the whole discharge process, thereby accelerating the liquid-liquid and liquid-solid conversion processes of lithium-sulfur battery.

Although these Li⁺ diffusion values are different from the values obtained by the previous electrochemical impedance spectroscopy test (see FIG. 22), their trends are the same.

### 5. Theoretical Simulation.

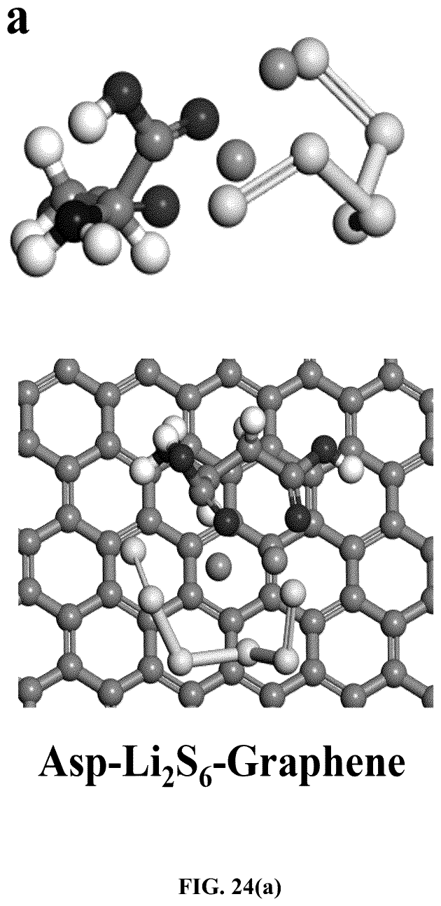

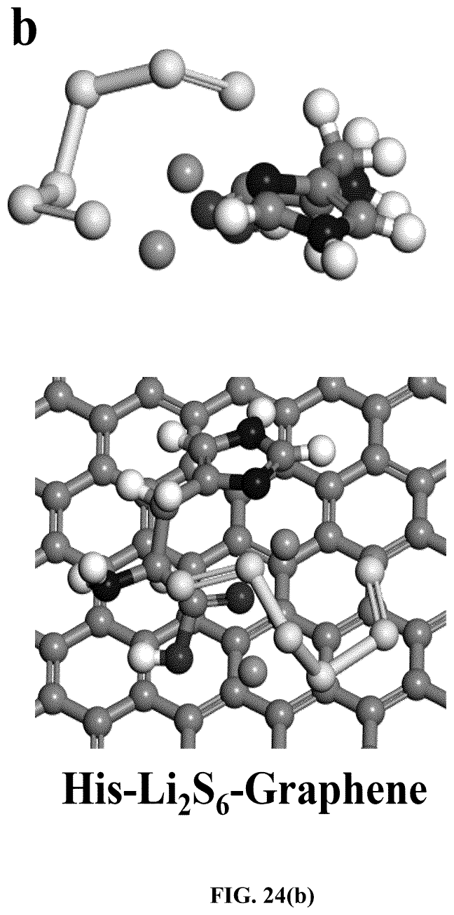

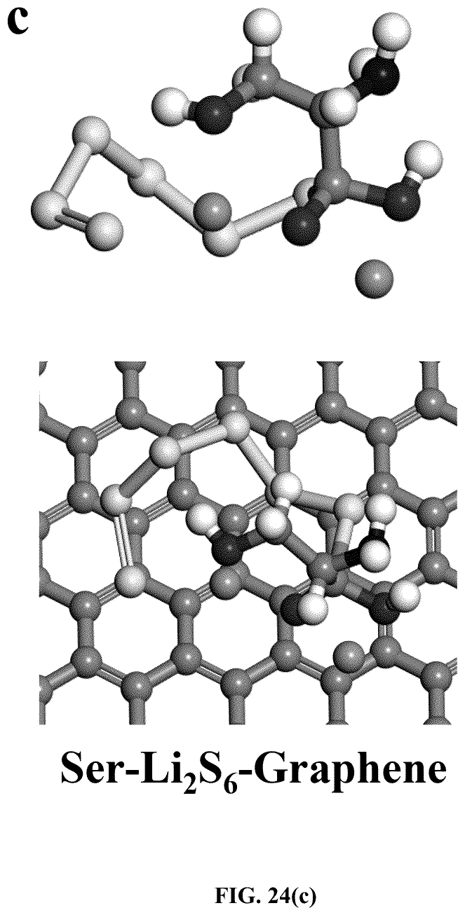

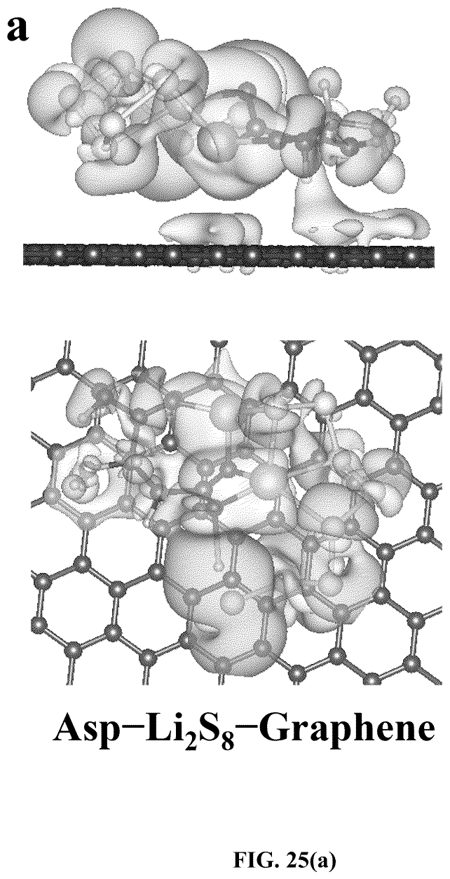

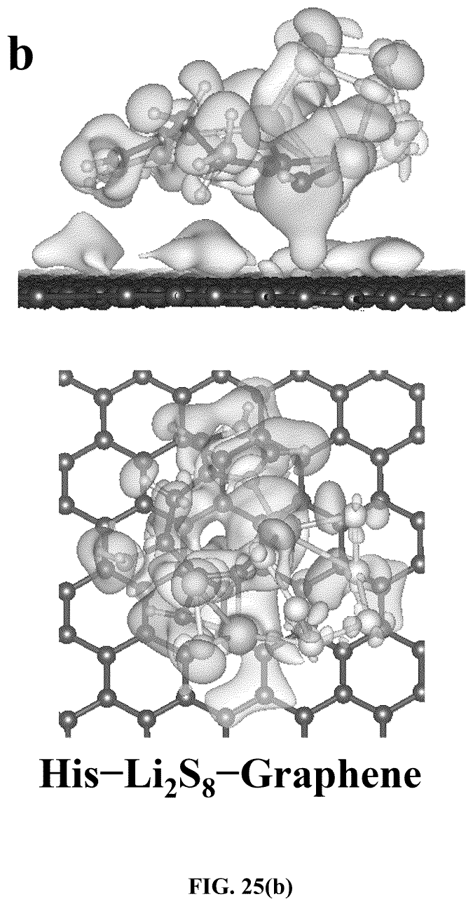

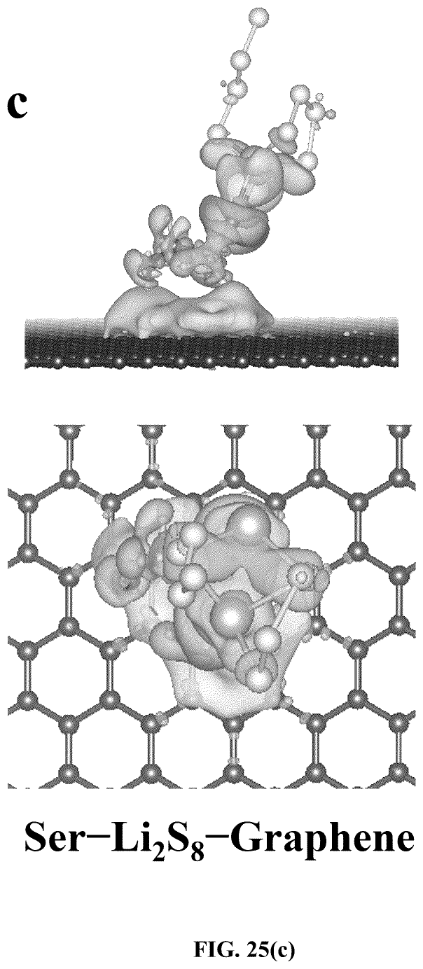

The above experimental results show that Ser can break the S—S bond, His accelerates Li⁺ transmission and Asp has excellent polysulfide adsorption capacity. In order to further reveal the synergistic effect of Ser, His and Asp, the initial configurations of three amino acids (Ser, His and Asp) and Li₂S₆ on graphene are first established, and the most stable configuration is obtained through sufficient structural optimization (see FIG. 24). Through an intuitive comparison of adsorption configuration, it can be seen that Asp containing two carboxyl groups fixes polysulfide through O—Li—O bond (see FIG. 24a), which highlights the key role of carboxyl group in stabilizing polysulfide. The carboxyl group has a strong electrophilicity, so that Asp can form a stable bonding relationship with polysulfide. In the battery, this strong carboxyl affinity enables Asp to efficiently adsorb and immobilize polysulfide, thereby slowing the shuttle effect of polysulfide; the O—Li—N bond formed by His is more conducive to the transfer of Li⁺ (see FIG. 24b). Through the O—Li—N bond, the nitrogen atom can more flexibly bond with Li⁺, which helps to improve the transfer efficiency. The electronegativity of nitrogen atom is relatively low, in contrast, the higher electronegativity of oxygen atom leads to a closer binding with Li⁺, which limits the free transfer of Li⁺. Due to the presence of hydroxyl group in Ser, making Ser has high electrophilicity and activity. When interacting with polysulfide, Ser produces the effect of electron axial stretching (see FIG. 25c), which promotes the loss of internal charge in polysulfide, thereby weakening the binding strength of Li—S bond. At the same time, the formation of the Li—O bond (see FIG. 24c) also enhances the ability of the hydroxyl group to react with the surrounding S—S bond, thereby promoting the cleavage of the S—S bond. These reactions contribute to the reduction process of polysulfide, thus improving the performance of the battery.

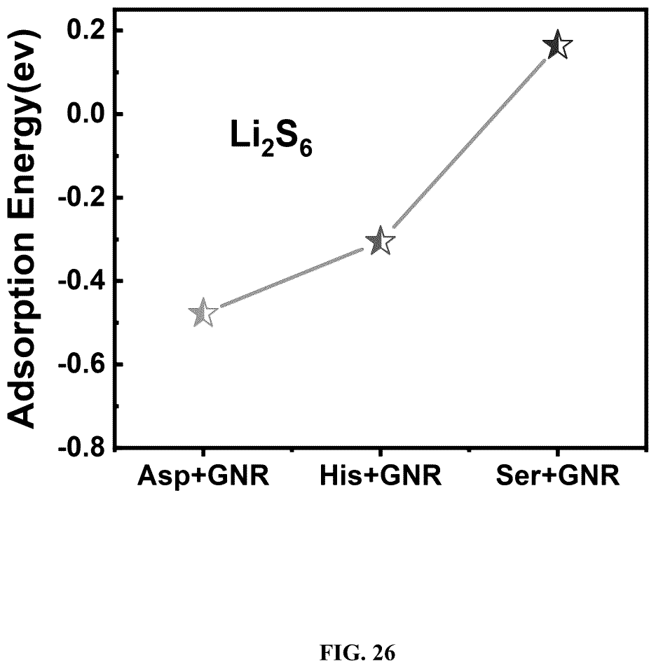

In order to quantify the anchoring ability of Ser, His and Asp to polysulfide, the adsorption energy of three amino acids for Li₂S₆ are calculated (see FIG. 26). Among them, the adsorption energy of Li₂S₆ on Asp is −0.5 eV, the adsorption energy on His is −0.3 eV and the adsorption energy on Ser is 0.15 eV. The order of the adsorption energy of the three amino acids is: Ser<His<Asp, indicating that Asp has the strongest anchoring ability to polysulfide, followed by His, and Ser has the weakest anchoring ability, which is consistent with the experimental results. (see FIG. 16).

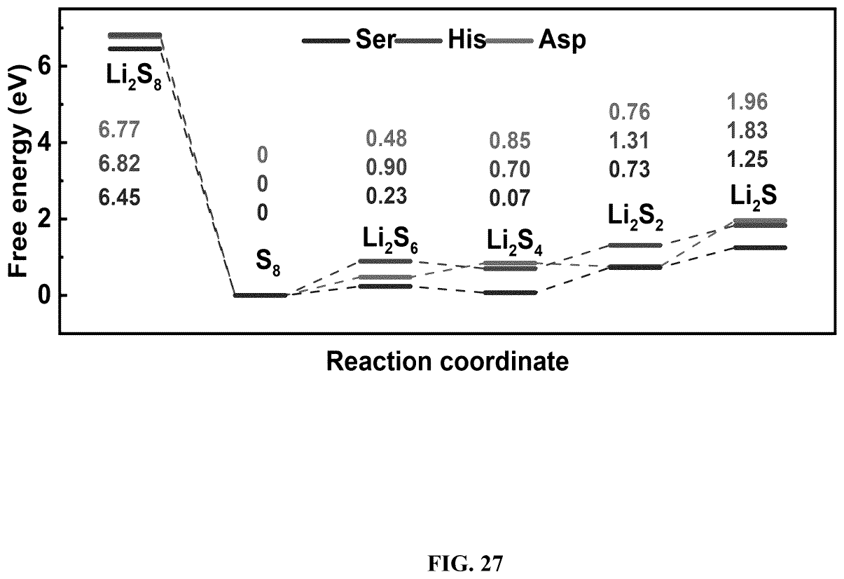

In order to evaluate the catalytic ability of Ser for polysulfide conversion, the reaction energy barrier is calculated for each reaction step of the sulfur reduction reaction. The relative energy evolution curve of the reaction process is shown in FIG. 27, in the discharge process of Se to Li₂S conversion, among the four steps of generating Li₂S₆, Li₂S₄, Li₂S₂ and Li₂S, the distribution reaction energy barrier of Ser is the lowest, indicating that it can catalyze the conversion reaction of lithium-sulfur battery more effectively.

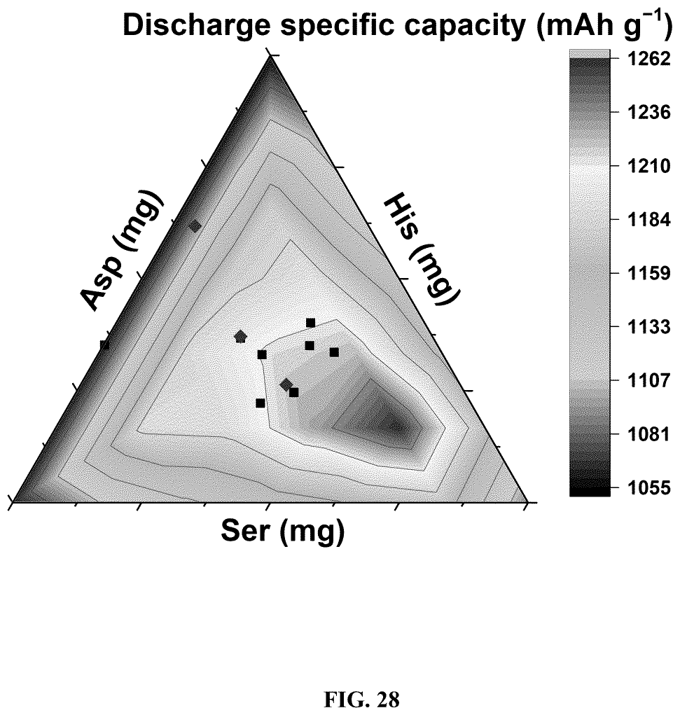

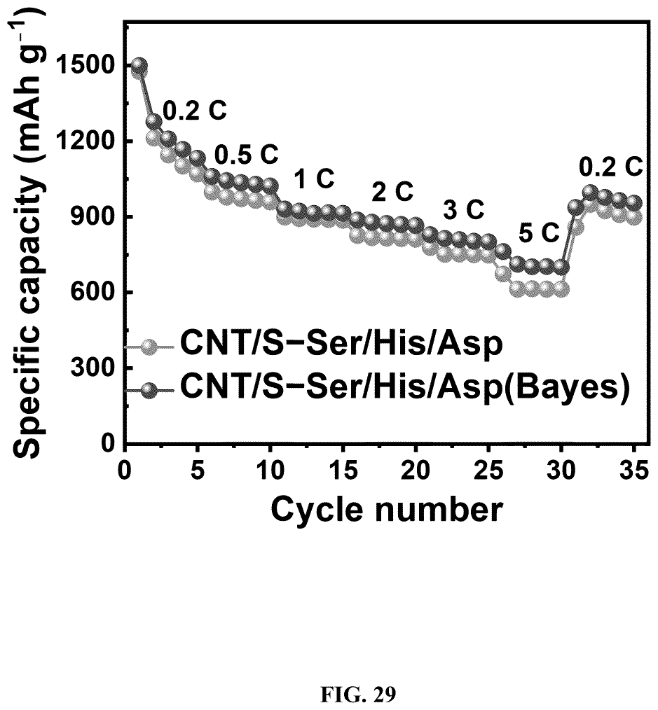

In addition, the Bayesian optimization method is used to predict the optimal design formula of Ser-His-Asp catalytic triad lithium-sulfur battery, based on the above experimental data, a training set containing formula data of several disks (such as amino acid composition ratio, carbon/sulfur/catalyst composition ratio, etc.) and performance data of several batteries corresponding to each formula is constructed. Using Bayesian optimization method to train the data, the battery performance can be directly predicted (see Table 2 and FIG. 28). The rate test is carried out according to the optimal ratio of Ser, His and Asp, after verification, the discharge specific capacity of the optimal ratio CNT/S-Ser/His/Asp cathode (Embodiment 7) is improved compared with the previous ratio of the battery (Embodiment 1) (see FIG. 29).

TABLE 2
The discharge specific capacity of Embodiment
2-11 at 0.2 C under different amino acid ratios
calculated by Bayesian optimization method.

| | | | Discharge specific capacity |
|---|---|---|---|
| | | | (mAh g⁻¹) at 0.2 C at the third |
| Ser (mg) | His (mg) | Asp (mg) | cycle |
| 1.11 | 0.66 | 1.23 | 1202.97 |
| 1.20 | 1.06 | 0.74 | 1205.99 |
| 1.27 | 0.74 | 0.99 | 1173.58 |
| 0.78 | 1.10 | 1.12 | 1191.35 |
| 1.13 | 1.21 | 0.66 | 1195.94 |
| 1.37 | 1.01 | 0.62 | 1222.42 |
| 0.96 | 0.99 | 1.05 | 1186.43 |
| 1.20 | 0.78 | 1.02 | 1182.46 |
| 0.78 | 1.10 | 1.12 | 1203.68 |
| 0.14 | 1.84 | 1.02 | 1152.71 |

In summary, the invention uses peptide-based materials Ser, His and Asp to construct a peptide-based mimetic enzyme by rationally designing active site, that is, Ser-His-Asp catalytic triplet, which preserves the function of the enzyme while reducing the inherent complexity of the enzyme. The catalytic mechanism of the Ser-His-Asp triplet in the battery is discussed in depth, and it is found that they each play a different role in the sulfur conversion kinetics: Asp adsorbs polysulfide with strong electrostatic attraction; through the nucleophilic attack ability of hydroxyl group, Ser is more likely to attack the S—S bond through deprotonation and ‘electronic stretching effect’, which promotes the cleavage of long-chain polysulfide to form short-chain polysulfide intermediate. The His synchronous transfer of N-rich atom promotes the transmission of Li⁺ in the electrolyte. The synergistic effect between the three significantly improves the redox reaction kinetics of lithium-sulfur battery, promotes the efficient conversion of polysulfide, accelerates Li⁺ transmission, and improves battery performance (1030 cycles at 0.5 C, decay rate of a single cycle is 0.057%).

The above disclosure is only the better embodiments of the invention, of course, it cannot be used to limit the scope of the right of the invention. Therefore, the equivalent change made according to the claim of the invention is still covered by the invention.

What is claimed is:

1. An amino acid concatemer synergistic sulfur conversion catalyst for lithium-sulfur battery, comprising an amino acid concatemer, the amino acid concatemer comprises serine (Ser), histidine (His), and aspartic acid (Asp).

2. The amino acid concatemer synergistic sulfur conversion catalyst for lithium-sulfur battery according to claim 1, comprising a conductive matrix, the amino acid concatemer is compounded on the conductive matrix.

3. The amino acid concatemer synergistic sulfur conversion catalyst for lithium-sulfur battery according to claim 1, the conductive matrix is a carbon material.

4. The amino acid concatemer synergistic sulfur conversion catalyst for lithium-sulfur battery according to claim 3, the carbon material is carbon nanotube.

5. A preparation method for an amino acid concatemer synergistic sulfur conversion catalyst for lithium-sulfur battery according to claim 3, comprising following steps: dispersing each amino acid and carbon material into a solvent for ultrasonic treatment.

6. The preparation method for an amino acid concatemer synergistic sulfur conversion catalyst for lithium-sulfur battery according to claim 5, a mass ratio of carbon material to Ser, His and Asp is 20˜60:x:y:z, x+y+z=3.

7. A cathode material of lithium-sulfur battery, comprising an active material sulfur-loaded cathode and an amino acid concatemer synergistic sulfur conversion catalyst for lithium-sulfur battery according to claim 1.

8. A cathode of lithium-sulfur battery, comprising a current collector and a lithium-sulfur battery cathode material coated on the current collector according to claim 7.

9. A preparation method for cathode of lithium-sulfur battery according to claim 8, comprising the following steps: dispersing the lithium-sulfur battery cathode material and a binder according to claim 6 into a solvent to form a slurry, then uniformly coating it on the current collector, and dried.

10. A lithium-sulfur battery, comprising an anode, a separator, a non-aqueous electrolyte, and a cathode according to claim 8.
